(19) United States
(12) Patent Application Publication
(10) Pub. No.: US 2026/0011294 A1
(43) Pub. Date: Jan. 8, 2026

(54) DISPLAY DEVICE AND ELECTRONIC DEVICE INCLUDING THE SAME

(71) Applicant: Samsung Display Co., LTD., Yongin-si (KR)

(72) Inventors: CHUNG SOCK CHOI, Yongin-si (KR); YOOMIN KO, Yongin-si (KR); SUNHO KIM, Yongin-si (KR); Hyewon Kim, Yongin-si (KR); JUCHAN PARK, Yongin-si (KR); Yerim Son, Yongin-si (KR); PILSUK LEE, Yongin-si (KR); SUNGJIN HONG, Yongin-si (KR)

(21) Appl. No.: 19/246,209

(22) Filed: Jun. 23, 2025

(30) Foreign Application Priority Data
Jul. 4, 2024 (KR) 10-2024-0088256

(51) Int. Cl. G09G 3/32; G09G 3/3233

(52) U.S. Cl. CPC G09G 3/32; G09G 3/3233; G09G 2330/021

(57) ABSTRACT

A display device includes a plurality of pixel circuit blocks each including at least one pixel driving circuit part including a plurality of transistors, a light-emitting element electrically connected to the pixel driving circuit part and including an anode electrode and a cathode electrode, a first power supply voltage line, a second power supply voltage line, a switching circuit part electrically connected to the pixel circuit blocks in a one-to-one basis and including a first switching element connected to the first power supply voltage line and turned on by a first voltage level, a second switching element connected to the second power supply voltage line and turned on by a second voltage level different from the first voltage level, and a data line electrically connected to the switching circuit part which provides the first voltage level or the second voltage level to the switching circuit part.

This application claims priority to Korean Patent Application No. 10-2024-0088256, filed on Jul. 4, 2024, and all the benefits accruing therefrom under 35 U.S.C. § 119, the content of which in its entirety is herein incorporated by reference.

### BACKGROUND

### 1. Technical Field

The invention generally relates to a display device and more particularly, to a display device which provides visual information.

### 2. Description of the Related Art

As information technology develops, the importance of display devices, which are a communication media between users and information, is being highlighted. Accordingly, the use of display devices such as a liquid crystal display device, an organic light emitting display device, a plasma display device, and the like is increasing.

The display device includes a light-emitting element and a pixel driving circuit for driving the light-emitting element. The light emitting element is driven by a pixel driving circuit and emits light.

### SUMMARY

In accordance with an embodiment, a display device with reduced power consumption is provided.

In accordance with an embodiment, an electronic device including the display device is provided.

A display device, according to an embodiment, includes a plurality of pixel circuit blocks each including at least one pixel driving circuit part including a plurality of transistors, a light-emitting element electrically connected to the pixel driving circuit part and including an anode electrode and a cathode electrode, a first power supply voltage line which receives a power supply voltage of a high level, a second power supply voltage line which receives a power supply voltage of a low level, a switching circuit part electrically connected to the plurality of pixel circuit blocks in a one-to-one basis and including a first switching element connected to the first power supply voltage line and which is turned on by a data voltage of a first voltage level and a second switching element connected to the second power supply voltage line and which is turned on by a data voltage of a second voltage level different from the first voltage level, and a data line electrically connected to the switching circuit part and which provides the data voltage of the first voltage level or the data voltage of the second voltage level to the switching circuit part.

In an embodiment, the switching circuit part selectively provides the power supply voltage of the high level or the power supply voltage of the low level to any one of the plurality of pixel circuit blocks electrically connected to the switching circuit part.

In an embodiment, the first switching element may be turned off by the data voltage of the second voltage level and the second switching element may be turned off by the data voltage of the first voltage level.

In an embodiment, when the first switching element is turned on, the second switching element may be turned off, and when the first switching element is turned off, the second switching element may be turned on.

In an embodiment, when the first switching element is a PMOS transistor, the second switching element may be a NMOS transistor, and when the first switching element is a NMOS transistor, the second switching element may be a PMOS transistor.

In an embodiment, a power line to which a common voltage is applied may be connected to the cathode electrode, and the power supply voltage may be a driving voltage having a voltage level higher than a voltage level of the common voltage.

In an embodiment, the plurality of transistors may include a switching transistor including a gate electrode controlled by a light-emitting control signal, a source electrode, and a drain electrode. The display device may further include an output power connection line connecting the source electrode of the switching transistor and the switching circuit part, and which selectively receives the power supply voltage of the high level or the power supply voltage of the low level through the switching circuit part.

In an embodiment, the display device may further include an output power connection line connecting the anode electrode and the switching circuit part, and which selectively receives the power supply voltage of the high level or the power supply voltage of the low level through the switching circuit part.

In an embodiment, the display device may further include an output power connection line connecting the cathode electrode and the switching circuit part, wherein the output power connection line selectively receives the power supply voltage of the high level or the power supply voltage of the low level through the switching circuit part.

In an embodiment, the display device may further include a separator disposed on the pixel driving circuit part and surrounding the pixel circuit blocks in a plan view, wherein the cathode electrode may be disconnected by the separator.

In an embodiment, a side surface of the separator may have a reverse tapered slope.

In an embodiment, the pixel driving circuit part may include an inorganic insulating layer disposed on a substrate, a first organic insulating layer disposed on the inorganic insulating layer, a second organic insulating layer disposed on the first organic insulating layer and defining a first sub-opening exposing at least a portion of the output power connection line, and a pixel defining layer disposed on the second organic insulating layer and defining a second sub-opening spatially connected to the first sub-opening.

In an embodiment, the display device may further include a connection pattern which is disposed on the pixel defining layer, which contacts the cathode electrode in an area overlapping an edge of the separator, and which contacts the output power connection line through the first and second sub-openings.

In an embodiment, the light-emitting element may further include a light-emitting layer disposed between the anode electrode and the cathode electrode, and overlapping a light-emitting area, and the connection pattern may have a shape surrounding the light-emitting area in a plan view.

In an embodiment, the connection pattern may be spaced apart from the light-emitting area in the plan view.

In an embodiment, the output power connection line may include a first conductive layer, a second conductive layer, and a third conductive layer sequentially stacked, wherein a side surface of each of the first and third conductive layers may protrude outward beyond a side surface of the second conductive layer.

In an embodiment, the cathode electrode may be disconnected by the output power connection line, and the cathode electrode may contact the side surface of the second conductive layer and the side surface of the third conductive layer.

In an embodiment, the pixel driving circuit part may include an inorganic insulating layer disposed on a substrate, a first organic insulating layer disposed on the inorganic insulating layer, a second organic insulating layer disposed on the first organic insulating layer and defining a first sub-opening exposing at least a portion of the output power connection line, a pixel defining layer disposed on the second organic insulating layer and defining a second sub-opening spatially connected to the first sub-opening, wherein the pixel defining layer may include an engraved pattern surrounding the pixel circuit blocks in a plan view.

In an embodiment, the cathode electrode may be disconnected by the engraved pattern.

A display device, according to an embodiment, includes a plurality of pixel circuit blocks each including at least one pixel driving circuit part including a driving transistor which generates a driving current and is a PMOS transistor, a light-emitting element electrically connected to the pixel driving circuit part and including an anode electrode and a cathode electrode, a first power supply voltage line which receives a power supply voltage of a high level, a second power supply voltage line which receives a power supply voltage of a low level, a switching circuit part electrically connected to the pixel circuit blocks in a one-to-one basis and including, a first switching element connected to the first power supply voltage line and which is turned on by a data voltage of a first voltage level and is turned off by a data voltage of a second voltage level different from the first voltage level, and a second switching element connected to the second power supply voltage line and which is turned off by the data voltage of the first voltage level and is turned on by the data voltage of the second voltage level, an output power connection line connecting a node between the cathode electrode and the first and second switching elements, wherein the output power connection line selectively receives the power supply voltage of the high level or the power supply voltage of the low level through the switching circuit part, and a data line electrically connected to the switching circuit part and which provides the data voltage of the first voltage level or the data voltage of the second voltage level to the switching circuit part.

In an embodiment, the switching circuit part may selectively provide the power supply voltage of the high level or the power supply voltage of the low level to any one of the pixel circuit blocks electrically connected to the switching circuit part.

In an embodiment, when the first switching element is turned on, the second switching element may be turned off, and when the first switching element is turned off, the second switching element may be turned on.

In an embodiment, the display device may further include a separator disposed on the pixel driving circuit part and surrounding the pixel circuit blocks in a plan view, wherein the cathode electrode may be disconnected by the separator.

In an embodiment, the pixel driving circuit part may include an inorganic insulating layer disposed on a substrate, a first organic insulating layer disposed on the inorganic insulating layer, a second organic insulating layer disposed on the first organic insulating layer and defining a first sub-opening exposing at least a portion of the output power connection line, and a pixel defining layer disposed on the second organic insulating layer and defining a second sub-opening spatially connected to the first sub-opening.

In an embodiment, the display device may further include a connection pattern disposed on the pixel defining layer, wherein the connection pattern contacts the cathode electrode in an area overlapping an edge of the separator, and wherein the connection pattern contacts the output power connection line through the first and second sub-openings.

In an embodiment, the output power connection line may include a first conductive layer, a second conductive layer, and a third conductive layer sequentially stacked, wherein a side surface of each of the first and third conductive layers may protrude outward beyond a side surface of the second conductive layer, wherein the cathode electrode may be disconnected by the output power connection line, and wherein the cathode electrode may contact the side surface of the second conductive layer and the side surface of the third conductive layer.

In an embodiment, the pixel driving circuit part may include an inorganic insulating layer disposed on a substrate, a first organic insulating layer disposed on the inorganic insulating layer, a second organic insulating layer disposed on the first organic insulating layer and defining a first sub-opening exposing at least a portion of the output power connection line, a pixel defining layer disposed on the second organic insulating layer and defining a second sub-opening spatially connected to the first sub-opening, the pixel defining layer may include an engraved pattern surrounding the pixel circuit blocks in a plan view, and the cathode electrode may be disconnected by the engraved pattern.

An electronic device, according to an embodiment, includes a display device and a processor which controls the display device, wherein the display device includes a plurality of pixel circuit blocks each including at least one pixel driving circuit part including a plurality of transistors, a light-emitting element electrically connected to the pixel driving circuit part and including an anode electrode and a cathode electrode, a first power supply voltage line which receives a power supply voltage of a high level, a second power supply voltage line which receives a power supply voltage of a low level, a switching circuit part electrically connected to the pixel circuit blocks on a one-to-one basis and including a first switching element connected to the first power supply voltage line and turned on by a data voltage of a first voltage level and a second switching element connected to the second power supply voltage line and turned on by a data voltage of a second voltage level different from the first voltage level, and a data line electrically connected to the switching circuit part and providing the data voltage of the first voltage level or the data voltage of the second voltage level to the switching circuit part.

A display device, according to an embodiment, may include a plurality of pixel circuit blocks each including at least one pixel driving circuit part including a driving transistor which generates a driving current and is a NMOS transistor, and a switching circuit part electrically connected on a one-to-one basis with the pixel circuit blocks and which selectively provides a power supply voltage of a high level or a power supply voltage of a low level. In this case, the power supply voltage of the high level may be applied to the pixel circuit blocks disposed in a high-brightness area of the display area, and the power supply voltage of the low level may be applied to the pixel circuit blocks disposed in a low-brightness area of the display area. Accordingly, a power consumption of the display device may be reduced.

In another embodiment, a display device may include a plurality of pixel circuit blocks each including at least one pixel driving circuit part including a driving transistor which generates a driving current and which is a PMOS transistor, and a switching circuit part electrically connected on a one-to-one basis with the pixel circuit blocks and which selectively provides a power supply voltage of a high level or a power supply voltage of a low level. In this case, the power supply voltage of the low level may be applied to the pixel circuit blocks disposed in a high-brightness area of the display area, and the power supply voltage of the high level may be applied to the pixel circuit blocks disposed in a low-brightness area of the display area. Accordingly, a power consumption of the display device may be reduced.

### BRIEF DESCRIPTION OF THE DRAWINGS

Illustrative, non-limiting embodiments will be more clearly understood from the following detailed description in conjunction with the accompanying drawings.

FIG. 1A is a plan view showing a display device, according to an embodiment.

FIG. 1B is a plan view showing a display device, according to an embodiment.

FIG. 2A is a circuit diagram illustrating an example of a circuit structure of a pixel and a switching circuit included in the display device of FIGS. 1A and 1B, according to an embodiment.

FIG. 2B is a circuit diagram illustrating an example of a circuit structure of a pixel and a switching circuit part included in the display device of FIGS. 1A and 1B, according to an embodiment.

FIG. 3 is a plan view schematically showing a portion of a display area of FIGS. 1A and 1B, according to an embodiment.

FIG. 4 is a plan view schematically showing a portion of a display area of FIGS. 1A and 1B, according to an embodiment.

FIG. 5 is a circuit diagram illustrating an example of a circuit structure of a pixel and a switching circuit part included in the display device of FIGS. 1A and 1B, according to an embodiment.

FIG. 6 is a circuit diagram illustrating an example of a circuit structure of a pixel and a switching circuit part included in the display device of FIGS. 1A and 1B, according to an embodiment.

FIG. 7 is a plan view schematically showing a portion of a display area of FIGS. 1A and 1B, according to an embodiment.

FIG. 8 is an enlarged plan view of one pixel circuit block, light emitting elements connected to the one pixel circuit block, and one switching circuit part of FIG. 7, according to an embodiment.

FIG. 9 is a cross-sectional view showing an example of a cross-section taken along line I-I′ of FIG. 8, according to an embodiment.

FIG. 10 is a cross-sectional view showing an example of a cross-section taken along line I-I′ of FIG. 8, according to an embodiment.

FIG. 11 is an enlarged plan view of one pixel circuit block, light emitting elements connected to the one pixel circuit block, and one switching circuit part of FIG. 7, according to an embodiment.

FIG. 12 is a cross-sectional view taken along line II-II′ of FIG. 11, according to an embodiment.

FIG. 13 is an enlarged plan view of one pixel circuit block, light emitting elements connected to the one pixel circuit block, and one switching circuit part of FIG. 7, according to an embodiment.

FIG. 14 is a cross-sectional view showing an example of a cross-section taken along line III-III′ of FIG. 13, according to an embodiment.

FIG. 15 is a cross-sectional view showing an example of a cross-section taken along line III-III′ of FIG. 13, according to an embodiment.

FIG. 16 is a plan view schematically showing a portion of a display area of FIGS. 1A and 1B, according to an embodiment.

FIG. 17 is an enlarged plan view of one pixel circuit block, light emitting elements connected to the one pixel circuit block, and one switching circuit part of FIG. 16, according to an embodiment.

FIG. 18 is a plan view schematically showing a portion of a display area of FIGS. 1A and 1B, according to an embodiment.

FIG. 19 is an enlarged plan view of one pixel circuit block, light emitting elements connected to the one pixel circuit block, and one switching circuit part of FIG. 18, according to an embodiment.

FIG. 20 is a block diagram showing an electronic device, according to an embodiment.

FIG. 21 are graphical images showing an electronic device, according to various embodiments.

### DETAILED DESCRIPTION

The invention may be subject to various modifications and may take on various forms. Specific embodiments will be illustrated in the drawings and described in detail in the text. However, this is not intended to limit the invention to the specific disclosed forms, but it should be understood to include all modifications, equivalents, and alternatives that fall within the spirit and scope of the invention.

Terms such as “first” and “second” may be used to describe various elements, but these elements should not be limited by these terms. These terms are used merely to distinguish one element from another. For example, a first element may be referred to as a second element without departing from the scope of the invention, and similarly, a second element may be referred to as a first element.

When an element is described as being “connected to” another element, it may be directly connected or coupled to the other element, or there may be intermediate elements present. Other expressions describing the relationship between components, such as “between” and “directly between” or “adjacent to” and “directly adjacent to,” should be interpreted in a similar manner.

The terminology used in this specification is for the purpose of describing particular embodiments only and is not intended to limit the invention. Singular expressions are intended to include the plural unless the context clearly indicates otherwise. In this specification, terms like “include”, “comprise” or “have” are intended to specify the presence of stated features, numbers, steps, operations, elements, parts, or combinations thereof, but do not preclude the presence or addition of one or more other features, numbers, steps, operations, elements, parts, or combinations thereof.

Terms such as “below,” “under,” “lower,” “beneath,” “above,” “upper,” “higher,” and “on” are used to describe the relationship between components as shown in the drawings. These terms are relative concepts and are explained based on the direction indicated in the drawings.

Unless otherwise defined, all terms used herein, including technical and scientific terms, have the same meaning as commonly understood by one of ordinary skill in the art to which this invention belongs. Terms generally defined in dictionaries should be interpreted as having meanings that are consistent with their use in the context of the relevant technology, and are not to be interpreted in an idealized or overly formal sense unless expressly defined herein.

Hereinafter, a display device according to an embodiment will be explained in detail with reference to the accompanying drawings. The same reference numerals are used for the same components in the drawings, and redundant descriptions of the same components will be omitted.

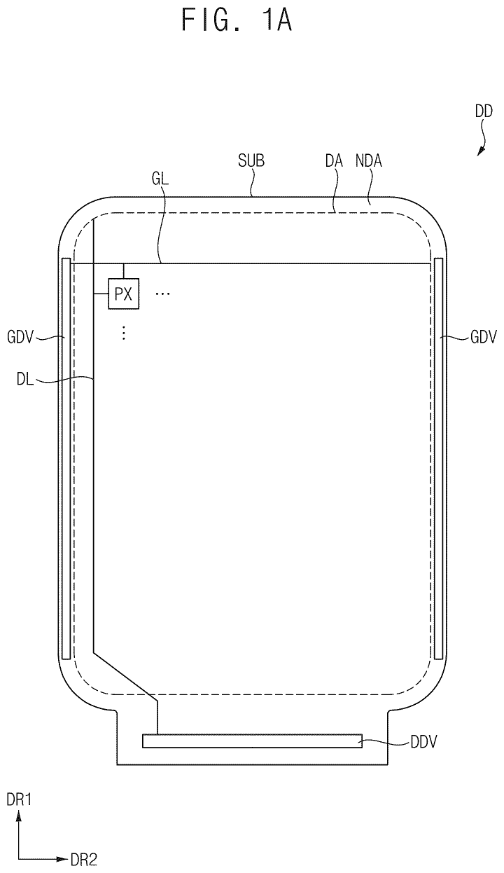

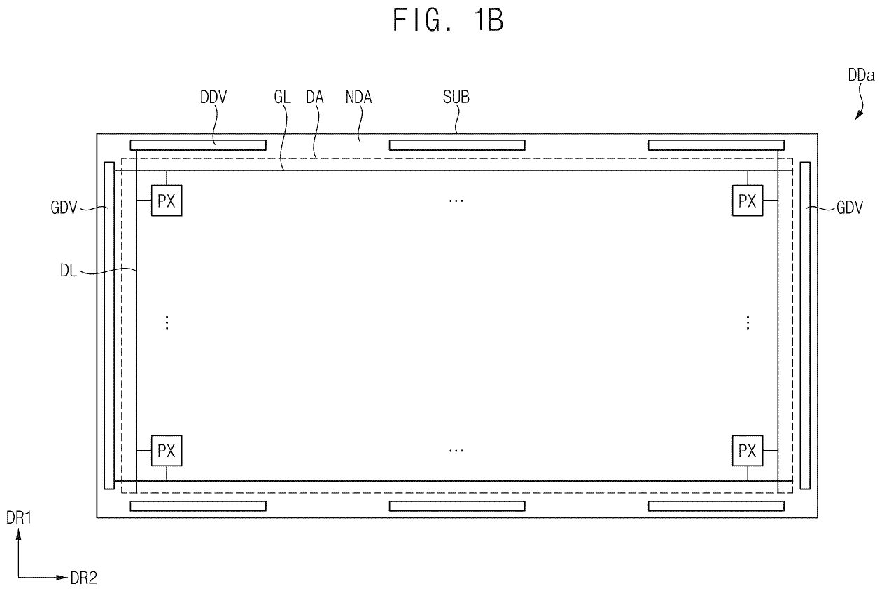

FIG. 1A is a plan view showing a display device according, to an embodiment. FIG. 1B is a plan view showing a display device, according to an embodiment.

In an embodiment and referring to FIGS. 1A and 1B, display devices DD and DDa may be devices that are activated according to electrical signals. For example, the display device DD of FIG. 1A may be a small display device used in small electronic devices such as a smartphone, a mobile phone, a smart watch, a game console, and a camera.

In an embodiment, the display device DDa of FIG. 1B may be a medium-to-large display device used in medium-to-large electronic devices such as a laptop, tablet PCs, a television, a computer monitor, an automotive monitor, and an external billboard. FIG. 1A shows the display device DD as an example of the small display device, and FIG. 1B shows the display device DDa as an example of the medium-to-large display device.

In an embodiment, the display devices DD and DDa may include the display area DA and the peripheral area NDA. The display area DA may be an area that generates light or displays an image by adjusting the transmittance of light provided from an external light source. The peripheral area NDA may be located around the display area DA. For example, the peripheral area NDA may surround at least a portion of the display area DA. In an embodiment, the peripheral area NDA may be an area that does not display an image. However, the invention is not necessarily limited to this, and the image may be displayed in at least portion of the peripheral area NDA. For example, a light-emitting element which emits light may be disposed in at least a portion of the peripheral area NDA.

In an embodiment, the display devices DD and DDa may include a substrate SUB, a plurality of pixels PX, a gate line GL, a data line DL, a data driver DDV, and a gate driver GDV.

In an embodiment, the substrate SUB may form the basis of the display devices DD and DDa. In an embodiment, examples of materials that can be used as the substrate SUB may include glass, quartz, silicon, polymer, or the like. These can be used alone or in combination with each other. In addition, the substrate SUB may have a single-layer structure or a multi-layer structure in which a plurality of layers including different materials are stacked.

In an embodiment, the pixels PX may be disposed in the display area DA on the substrate SUB. The pixels PX may be electrically connected to the gate line GL and the data line DL. For example, the pixels PX may be disposed in a matrix form along a first direction DR1 and a second direction DR2. Each of the pixels PX may include a pixel driving circuit and a light-emitting element. The light-emitting element may emit light. For example, the light-emitting element may be an organic light-emitting diode or an inorganic-light emitting diode.

In an embodiment, the gate line GL and the data line DL may cross each other. For example, the gate line GL may extend in the first direction DR1 and be disposed along the second direction DR2. The data line DL may extend in the second direction DR2 and be disposed along the first direction DR1. However, the invention is not necessarily limited thereto.

In an embodiment, the data driver DDV may be disposed in the peripheral area NDA on the substrate SUB. The data driver DDV may generate a data voltage. The data driver DDV may output the data voltage to the data line DL. The data voltage may be applied to the pixels PX through the data line DL.

In an embodiment, the data driver DDV may be mounted on the substrate SUB. However, the invention is not necessarily limited to thereto, and the data driver DDV may be disposed on a flexible film coupled to the substrate SUB. That is, the data driver DDV may be disposed on a flexible film using a chip on film (COF) method.

In an embodiment, the display device DDa of FIG. 1B may include a plurality of data drivers DDV. For example, the data drivers DDV may be disposed on both sides of the display area DA in the second direction DR2. For example, the data drivers DDV may be disposed along a long side of the substrate SUB. However, the invention is not necessarily limited thereto.

In an embodiment, the gate driver GDV may be disposed in the peripheral area NDA on the substrate SUB. The gate driver GDV may generate a gate signal. The gate driver GDV may output the gate signal to the gate line GL. The gate signal may be applied to the pixels PX through the gate line GL. In an embodiment, the gate driver GDV may be disposed on both sides of the display area DA in the first direction DR1. However, the invention is not necessarily limited thereto.

In an embodiment, a light-emitting driver which generates a light-emitting control signal may be further disposed in the peripheral area NDA. The light-emitting control signal may be applied to the pixels PX through a light-emitting control line.

In an embodiment, the number and arrangement relationship of the data drivers DDV shown in FIGS. 1A and 1B may vary depending on the embodiments, and the number and arrangement relationship of the gate drivers GDV shown in FIGS. 1A and 1B may vary depending on the embodiments.

In an embodiment, although the display device DD in FIG. 1A is shown as having a substantially rectangular planar shape with a short side extending in the first direction DR1 and a long side extending in the second direction DR2, the invention is not necessarily limited thereto.

In an embodiment, although the display device DDa is shown in FIG. 1B as having a rectangular planar shape with a long side extending in the first direction DR1 and a short side extending in the second direction DR2, the invention is necessarily limited to thereto. That is, the planar shape of the display devices DD and DDa may vary depending on the embodiments.

Descriptions referring to the following drawings may be equally applied to the display device DD of FIG. 1A and the display device DDa of FIG. 1B. Therefore, hereinafter, for convenience of explanation, the expression will be unified as the display device DD.

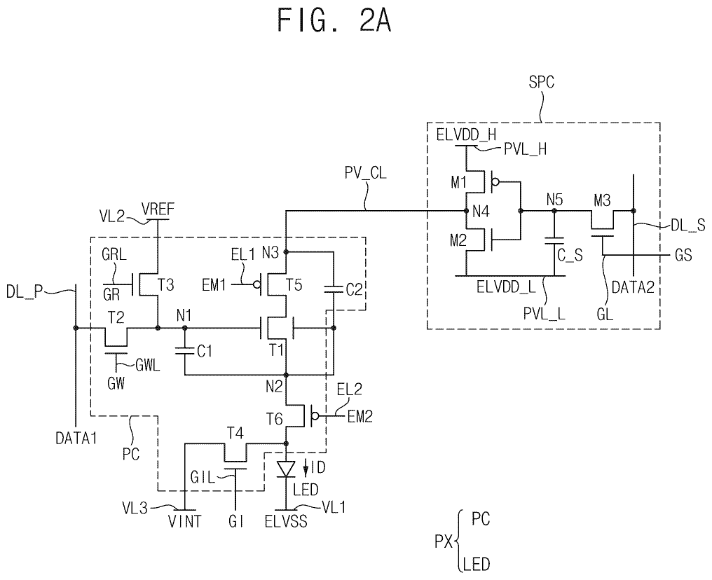

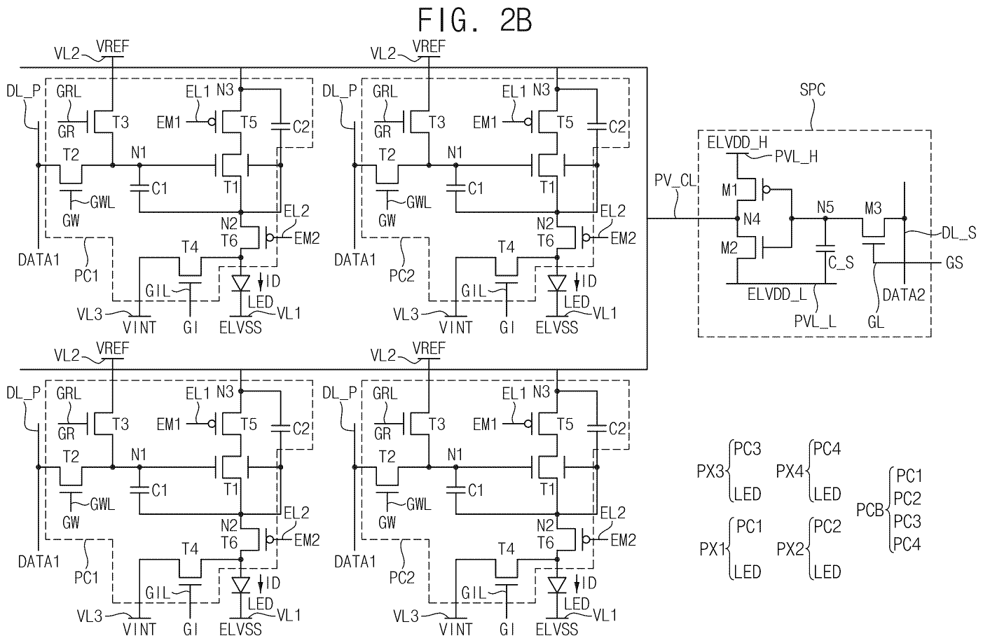

FIG. 2A is a circuit diagram illustrating an example of a circuit structure of a pixel and a switching circuit included in the display device of FIGS. 1A and 1B, according to an embodiment. FIG. 2B is a circuit diagram illustrating an example of a circuit structure of a pixel and a switching circuit part included in the display device of FIGS. 1A and 1B, according to an embodiment.

In an embodiment and referring to FIGS. 2A and 2B, one pixel PX may include a pixel driving circuit part PC and a light-emitting element LED electrically connected to the pixel driving circuit part PC. The pixel driving circuit part PC may generate a driving current ID, and the light-emitting element LED may generate light based on the driving current ID.

In an embodiment, the pixel driving circuit part PC may include a first transistor T1, a second transistor T2, a third transistor T3, a fourth transistor T4, a fifth transistor T5, a sixth transistor T6, a first capacitor C1, and a second capacitor C2.

In an embodiment, each of the first transistor T1, the second transistor T2, the third transistor T3, and the fourth transistor T4 is an NMOS transistor, and the fifth transistor T5 and the sixth transistor T6 is a PMOS transistor. However, the invention is not necessarily limited thereto. For example, in an embodiment, the first transistor T1 may be an NMOS transistor. Some of the second transistor T2, the third transistor T3, the fourth transistor T4, the fifth transistor T5, and the sixth transistor T6 may be NMOS transistors, and others may be PMOS transistors. In another embodiment, the first transistor T1, the second transistor T2, the third transistor T3, the fourth transistor T4, the fifth transistor T5, and the sixth transistor T6 may all be NMOS transistors.

Here, the first transistor T1 may be referred to as a driving transistor, and each of the second transistor T2, the third transistor T3, the fourth transistor T4, the fifth transistor T5, and the sixth transistor T6 may be referred to as a switching transistor.

In an embodiment, when the pixel driving circuit part PC includes an NMOS transistor and a PMOS transistor, an active pattern of the NMOS transistor may include an oxide semiconductor, and an active pattern of the PMOS transistor may include a silicon semiconductor. However, the invention is not necessarily limited to this, and the active pattern of the NMOS transistor may include a silicon semiconductor, and the active pattern of the PMOS transistor may include an oxide semiconductor.

In an embodiment, the pixel driving circuit part PC may be electrically connected to the first gate line GWL, a second gate line GRL, a third gate line GIL, a first data line DL_P, a first light-emitting control line EL1, a second light-emitting control line EL2, a first voltage line VL1, a second voltage line VL2, and a third voltage line VL3. The first gate line GWL may transmit a first gate signal GW. The second gate line GRL may transmit a second gate signal GR. The third gate line GIL may transmit a third gate signal GI. The first data line DL_P may transmit a first data voltage DATA1. The first light-emitting control line EL1 may transmit a first light-emitting control signal EM1. The second first light-emitting control line EL2 may transmit a second light-emitting control signal EM2. The first voltage line VL1 may transmit a first power supply voltage ELVSS. The second voltage line VL2 may transmit a reference voltage VREF. The third voltage line VL3 may transmit an initialization voltage VINT.

In an embodiment, the first transistor T1 may include a gate electrode, a first electrode, and a second electrode. The gate electrode of the first transistor T1 may be connected to a first node N1. The first electrode of the first transistor T1 may be connected to a second node N2. The second electrode of the first transistor T1 may be connected to the second electrode (e.g., a drain electrode) of the fifth transistor T5. The first transistor T1 may provide a driving current ID to the light-emitting element LED. In an embodiment, the first electrode of the first transistor T1 may be a source electrode, and the second electrode of the first transistor T1 may be a drain electrode.

The first transistor T1 may further include a back gate electrode. The back gate electrode of the first transistor T1 may be connected to a node between the second capacitor C2 and the second node N2.

In an embodiment, the second transistor T2 may include a gate electrode, a first electrode, and a second electrode. The gate electrode of the second transistor T2 may be connected to the first gate line GWL. The first electrode of the second transistor T2 may be connected to the first node N1. The second electrode of the second transistor T2 may be connected to the first data line DL_P. In an embodiment, the first electrode of the second transistor T2 may be a source electrode, and the second electrode of the second transistor T2 may be a drain electrode. In another embodiment, the first electrode of the second transistor T2 may be a drain electrode, and the second electrode of the second transistor T2 may be a source electrode.

In an embodiment, the gate electrode of the second transistor T2 may receive the first gate signal GW through the first gate line GWL. The second transistor T2 may be turned on or off in response to the first gate signal GW. For example, when the first gate signal GW has an activation level, the second transistor T2 may be turned on. In this case, the second transistor T2 may provide the first data voltage DATA1 to the first node N1 through the first data line DL_P. Conversely, when the first gate signal GW has an inactivation level, the second transistor T2 may be turned off. In this case, the second transistor T2 may block the supply of the first data voltage DATA1.

In an embodiment, the third transistor T3 may include a gate electrode, a first electrode, and a second electrode. The gate electrode of the third transistor T3 may be connected to the second gate line GRL. The first electrode of the third transistor T3 may be connected to the first node N1. The second electrode of the third transistor T3 may be connected to the second voltage line VL2. In an embodiment, the first electrode of the third transistor T3 may be a source electrode, and the second electrode of the third transistor T3 may be a drain electrode. In another embodiment, the first electrode of the third transistor T3 may be a drain electrode, and the second electrode of the third transistor T3 may be a source electrode.

In an embodiment, the gate electrode of the third transistor T3 may receive the second gate signal GR through the second gate line GRL. The third transistor T3 may be turned on or off in response to the second gate signal GR. For example, when the second gate signal GR has an activation level, the third transistor T3 may be turned on. In this case, the third transistor T3 may provide the reference voltage VREF to the first node N1 through the second voltage line VL2. Conversely, when the second gate signal GR has an inactivation level, the third transistor T3 may be turned off. In this case, the third transistor T3 may block the supply of the reference voltage VREF.

In an embodiment, the fourth transistor T4 may include a gate electrode, a first electrode, and a second electrode. The gate electrode of the fourth transistor T4 may be connected to the third gate line GIL. The first electrode of the fourth transistor T4 may be connected to the anode electrode of the light-emitting element LED. The second electrode of the fourth transistor T4 may be connected to the third voltage line VL3. In an embodiment, the first electrode of the fourth transistor T4 may be a source electrode, and the second electrode of the fourth transistor T4 may be a drain electrode. In another embodiment, the first electrode of the fourth transistor T4 may be a drain electrode, and the second electrode of the fourth transistor T4 may be a source electrode.

The gate electrode of the fourth transistor T4 may receive the third gate signal GI through the third gate line GIL. The fourth transistor T4 may be turned on or off in response to the third gate signal GI. For example, when the third gate signal GI has an activation level, the fourth transistor T4 may be turned on. In this case, the fourth transistor T4 may provide the initialization voltage VINT to the second electrode (e.g., a drain electrode) of the sixth transistor T6 through the third voltage line VL3. Conversely, when the third gate signal GI has an inactivation level, the fourth transistor T4 may block the supply of the initialization voltage VINT.

In an embodiment, the fifth transistor T5 may include a gate electrode, a first electrode, and a second electrode. The gate electrode of the fifth transistor T5 may be connected to the first light-emitting control line EL1. The first electrode of the fifth transistor T5 may be connected to a third node N3. The second electrode of the fifth transistor T5 may be connected to the second electrode (e.g., a drain electrode) of the first transistor T1. In an embodiment, the first electrode of the fifth transistor T5 may be a source electrode, and the second electrode of the fifth transistor T5 may be a drain electrode. In another embodiment, the first electrode of the fifth transistor T5 may be a drain electrode, and the second electrode of the fifth transistor T5 may be a source electrode.

In an embodiment, the sixth transistor T6 may include a gate electrode, a first electrode, and a second electrode. The gate electrode of the sixth transistor T6 may be connected to the second light-emitting control line EL2. The first electrode of the sixth transistor T6 may be connected to the second node N2. The second electrode of the sixth transistor T6 may be connected to the anode electrode of the light-emitting element LED. In an embodiment, the first electrode of the sixth transistor T6 may be a source electrode, and the second electrode of the sixth transistor T6 may be a drain electrode. In another embodiment, the first electrode of the sixth transistor T6 may be a drain electrode, and the second electrode of the sixth transistor T6 may be a source electrode.

In an embodiment, the gate electrode of the fifth transistor T5 may receive the first light-emitting control signal EM1 through the first light-emitting control line EL1. The fifth transistor T5 may be turned on or off in response to the first light-emitting control signal EM1. Likewise, the gate electrode of the sixth transistor T6 may receive the second light-emitting control signal EM2 through the second light-emitting control line EL2. The sixth transistor T6 may be turned on or off in response to the second light-emitting control signal EM2.

For example, in an embodiment, when both the first light-emitting control signal EM1 and the second light-emitting control signal EM2 have an activation level, both the fifth transistor T5 and the sixth transistor T6 may be turned on. In this case, the fifth transistor T5 and the sixth transistor T6 may provide the driving current ID generated in the first transistor T1 to the anode electrode of the light-emitting element LED. Conversely, when both the first light-emitting control signal EM1 and the second light-emitting control signal EM2 have inactivation levels, both the fifth transistor T5 and the sixth transistor T6 may be turned off. In this case, the fifth transistor T5 and the sixth transistor T6 may block the supply of the driving current ID generated by the first transistor T1.

In an embodiment, the first capacitor C1 may include a first electrode and a second electrode. The first electrode of the first capacitor C1 may be connected to the first node N1. The second electrode of the first capacitor C1 may be connected to the second node N2. The first capacitor C1 may be charged and discharged according to the first data voltage DATA1 provided to the first node N1.

In an embodiment, the second capacitor C2 may include a first electrode and a second electrode. The first electrode of the second capacitor C2 may be connected to the third node N3. The second electrode of the second capacitor C2 may be connected to the back gate electrode of the first transistor T1 and the second node N2.

In an embodiment, the light-emitting element LED may include an anode electrode and a cathode electrode. The anode electrode of the light-emitting element LED may be connected to the second electrode of the sixth transistor T6. The cathode electrode of the light-emitting element LED may be connected to the first voltage line VL1. The cathode electrode of the light-emitting element LED may receive the first power supply voltage ELVSS through the first voltage line VL1.

In an embodiment, the display device DD may further include a switching circuit part SPC of FIG. 2A electrically connected to the pixel driving circuit part PC of FIG. 2A (or a pixel circuit block PCB of FIG. 2B). The switching circuit part SPC may selectively provide a second power supply voltage ELVDD_H of a high level or a second power supply voltage ELVDD_L of a low level to the pixel driving circuit part PC of FIG. 2A (or the pixel circuit block PCB of FIG. 2B).

In an embodiment, the switching circuit part SPC may be electrically connected to the pixel driving circuit part PC of FIG. 2A (or the pixel circuit block PCB of FIG. 2B) through an output power connection line PV_CL. Specifically, the output power connection line PV_CL may be connected to the third node N3 of the pixel driving circuit part PC of FIG. 2A (or the pixel circuit block PCB of FIG. 2B) and a fourth node N4 of the switching circuit part SPC. Accordingly, the output power connection line PV_CL may selectively receive the second power supply voltage ELVDD_H of the high level or the second power supply voltage ELVDD_L of the low level.

For example, in an embodiment, each of the second power supply voltage ELVDD_H of the high level and the second power supply voltage ELVDD_L of the low level may be a driving voltage having a higher voltage level than the first power supply voltage ELVSS. In this case, the first power supply voltage ELVSS may be referred to as a common voltage.

In an embodiment, the switching circuit part SPC may include a first switching element M1, a second switching element M2, a third switching element M3, and a third capacitor C_S. In an embodiment, the first switching element M1 may be a PMOS transistor, and the second switching element M2 may be an NMOS transistor. However, the invention is not necessarily limited to thereto, and in another embodiment, the first switching element M1 may be an NMOS transistor, and the second switching element M2 may be a PMOS transistor.

In an embodiment, the third switching element M3 may be an NMOS transistor. However, the invention is not necessarily limited thereto, and the third switching element M3 may be a PMOS transistor.

In an embodiment, a first power supply voltage line PVL_H, a second power supply voltage line PVL_L, a gate line GL, and a second data line DL_S may be electrically connected to the switching circuit part SPC. The first power supply voltage line PVL_H may transmit the second power supply voltage ELVDD_H of the high level. The second power supply voltage line PVL_L may transmit the second power supply voltage ELVDD_L of the low level. The gate line GL may transmit a gate signal GS. The second data line DL_S may transmit a second data voltage DATA2.

In an embodiment, the first switching element M1 may include a gate electrode, a first electrode, and a second electrode. The gate electrode of the first switching element M1 may be connected to the fifth node N5. The first electrode of the first switching element M1 may be connected to the first power supply voltage line PVL_H. The second electrode of the first switching element M1 may be connected to the fourth node N4. In an embodiment, the first electrode of the first switching element M1 may be a source electrode, and the second electrode of the first switching element M1 may be a drain electrode. In another embodiment, the first electrode of the first switching element M1 may be a drain electrode, and the second electrode of the first switching element M1 may be a source electrode.

In an embodiment, the second switching element M2 may include a gate electrode, a first electrode, and a second electrode. The gate electrode of the second switching element M2 may be connected to a fifth node N5. The first electrode of the second switching element M2 may be connected to the fourth node N4, and the second electrode of the second switching element M2 may be connected to the second power supply voltage line PVL_L. In an embodiment, the first electrode of the second switching element M2 may be a source electrode, and the second electrode of the second switching element M2 may be a drain electrode. In another embodiment, the first electrode of the second switching element M2 may be a drain electrode, and the second electrode of the second switching element M2 may be a source electrode.

In an embodiment, the third switching element M3 may include a gate electrode, a first electrode, and a second electrode. The gate electrode of the third switching element M3 may be connected to the gate line GL. The first electrode of the third switching element M3 may be connected to the fifth node N5. The second electrode of the third switching element M3 may be connected to the second data line DL_S. In an embodiment, the first electrode of the third switching element M3 may be a source electrode, and the second electrode of the third switching element M3 may be a drain electrode. In another embodiment, the first electrode of the third switching element M3 may be a drain electrode, and the second electrode of the third switching element M3 may be a source electrode.

In an embodiment, the third capacitor C_S may include a first electrode and a second electrode. The first electrode of the third capacitor C_S may be connected to the second power supply voltage line PVL_L. Accordingly, the first electrode of the third capacitor C_S may receive the second power supply voltage ELVDD_L of the low level. The second electrode of the third capacitor C_S may be connected to the fifth node N5.

In an embodiment, the gate electrode of the third switching element M3 may receive the gate signal GS through the gate line GL. The third switching element M3 may be turned on or off in response to the gate signal GS.

In an embodiment, the gate signal GS may be the same as the first gate signal GW. In this case, the gate line GL which transmits the gate signal GS and the first gate line GWL which transmits the first gate signal GW may be a single gate line. In another embodiment, the gate line GL which transmits the gate signal GS may be independent from the first gate line GWL which transmits the first gate signal GW. However, the invention is not necessarily limited to this, and the gate signal GS may be the same as the second gate signal GR or the third gate signal GI.

For example, in an embodiment, when the gate signal GS has an activation level, the third switching element M3 may be turned on. In this case, the third switching element M3 may provide the second data voltage DATA2 of a first voltage level or the second data voltage DATA2 of a second voltage level different from the first voltage level to the gate electrode of the first switching element M1 and the gate electrode of the second switching element M2 through the second data line DL_S.

For example, in an embodiment, when the first switching element M1 is a PMOS transistor and the second switching element M2 is an NMOS transistor, the first voltage level may be a low level and the second voltage level may be a high level.

In an embodiment, when the third switching element M3 provides the second data voltage DATA2 of the first voltage level to the gate electrode of the first switching element M1 and the gate electrode of the second switching element M2, the first switching element M1 may be turned on and the second switching element M2 may be turned off. In this case, the first switching element M1 may provide the second power supply voltage ELVDD_H of the high level to the output power connection line PV_CL. Accordingly, the output power connection line PV_CL may transmit the second power supply voltage ELVDD_H of the high level to the pixel driving circuit part PC of FIG. 2A (or the pixel circuit block PCB of FIG. 2B).

In an embodiment, when the third switching element M3 provides the second data voltage DATA2 of the second voltage level to the gate electrode of the first switching element M1 and the gate electrode of the second switching element M2, the first switching element M1 may be turned off and the second switching element M2 may be turned on. In this case, the second switching element M2 may provide the second power supply voltage ELVDD_L of the low level to the output power connection line PV_CL. Accordingly, the output power connection line PV_CL may transmit the second power supply voltage ELVDD_L of the low level to the pixel driving circuit part PC of FIG. 2A (or the pixel circuit block PCB of FIG. 2B).

In an embodiment, as shown in FIG. 2A, one switching circuit part SPC may be electrically connected to one pixel driving circuit part PC. That is, the switching circuit part SPC may be electrically connected to the pixel driving circuit part PC on a one-to-one basis.

In another embodiment, one switching circuit part SPC may be electrically connected to at least one pixel driving circuit part. That is, the switching circuit part SPC may be electrically connected to the at least one pixel driving circuit part in a one-to-many basis. For example, as shown in FIG. 2B, one switching circuit part SPC may electrically connect one pixel circuit block PCB including pixel driving circuit parts PC1, PC2, PC3, and PC4 having the same circuit structure through the output power connection line PV_CL. At this time, each of pixels PX1, PX2, PX3, and PX4 may include the pixel driving circuit parts PC1, PC2, PC3, and PC4 and the light-emitting element LED electrically connected to each of the pixel driving circuit parts PC1, PC2, PC3, and PC4.

In an embodiment, the number of pixel driving circuit parts of the pixel circuit block PCB shown in FIG. 2B is an example, and the pixel circuit block PCB may include at least one pixel driving circuit part including a plurality of transistors.

In addition, FIGS. 2A and 2B show that the pixel driving circuit part PC, PC1, PC2, PC3, and PC4 of each pixel PX, PX1, PX2, PX3, and PX4 includes six transistors and two capacitors, but the invention is not necessarily limited thereto. For example, the pixel driving circuit part PC, PC1, PC2, PC3, and PC4 of each pixel PX, PX1, PX2, PX3, and PX4 may include two transistors and one capacitor. In this case, the driving transistor which generates the driving current may be an NMOS transistor.

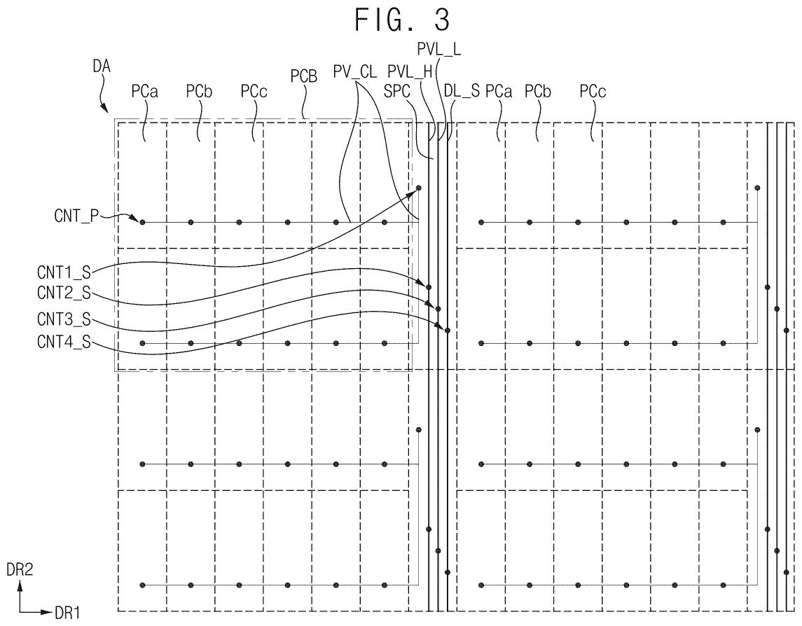

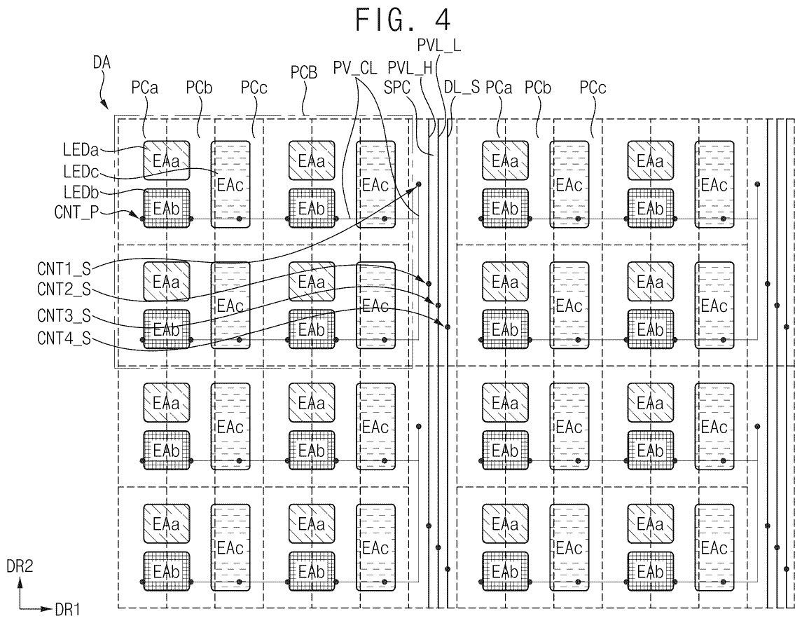

FIGS. 3 and 4 are plan views schematically showing a portion of a display area of FIGS. 1A and 1B, according to an embodiment.

In an embodiment and referring to FIGS. 3 and 4, the display device DD may include first, second, and third pixel driving circuit parts PCa, PCb, and PCc, respectively, first, second, third light-emitting elements LEDa, LEDb, and LEDc, respectively, and the switching circuit part SPC disposed in the display area DA.

In an embodiment, the pixel driving circuit parts PCa, PCb, and PCc may correspond to the pixel driving circuit parts PC, PC1, PC2, PC3, and PC4 shown in FIGS. 2A and 2B, respectively. That is, the pixel driving circuit parts PCa, PCb, and PCc may have the same circuit structure as the pixel driving circuit parts PC, PC1, PC2, PC3, and PC4 shown in FIGS. 2A and 2B, respectively,

For example, in an embodiment, the pixel driving circuit parts PCa, PCb, and PCc may be sequentially arranged along the first direction DR1 in a rectangular shape. However, the invention is not necessarily limited thereto, and the shape and arrangement of the pixel driving circuit parts PCa, PCb, and PCc may vary depending on the embodiments.

In an embodiment, the light-emitting elements LEDa, LEDb, and LEDc may correspond to the light-emitting elements LED shown in FIGS. 2A and 2B, respectively.

In an embodiment, the display area DA may include first, second, and third light-emitting areas EAa, EAb, and EAc, respectively. The first light-emitting element LEDa may be disposed in the first light-emitting area EAa, the second light-emitting element LEDb may be disposed in the second light-emitting area EAb, and the third light-emitting element LEDc may be disposed in the third light-emitting area EAc.

In an embodiment, the light-emitting elements LEDa, LEDb, and LEDc may emit light of different colors. For example, the first light-emitting element LEDa may emit light of red, the second light-emitting element LEDb may emit light of green, and the third light-emitting element LEDc may emit light of blue. Accordingly, the first light-emitting area EAa may emit light of red, the second light-emitting area EAb may emit light of green, and the third light-emitting area EAc may emit light of blue. However, the invention is not necessarily limited thereto.

For example, in an embodiment, the light-emitting areas EAa, EAb, and EAc may be arranged in an S-stripe type. However, the invention is not necessarily limited to this, and the arrangement of the light-emitting areas EAa, EAb, and EAc may vary depending on the embodiments.

In an embodiment, the light-emitting elements LEDa, LEDb, and LEDc may be connected to the pixel driving circuit parts PCa, PCb, and PCc, respectively. For example, the first light-emitting element LEDa may be connected to the first pixel driving circuit part PCa, the second light-emitting element LEDb may be connected to the second pixel driving circuit part PCb, and the third light-emitting element LEDa may be connected to the third pixel driving circuit part PCc. Accordingly, the first pixel driving circuit part PCa and the first light-emitting element LEDa may form one pixel, the second pixel driving circuit part PCb and the second light-emitting element LEDb may form one pixel, and the third pixel driving circuit part PCc and the third light-emitting element LEDc may form one pixel.

In an embodiment, the switching circuit part SPC may be electrically connected to the pixel circuit block PCB on a one-to-one basis. One switching circuit part SPC may be disposed around one pixel circuit block PCB.

For example, in an embodiment, the pixel circuit block PCB may be repeatedly arranged along the first direction DR1 and the second direction DR2.

In an embodiment, the switching circuit part SPC may correspond to the switching circuit part SPC shown in FIGS. 2A and 2B. That is, the switching circuit part SPC may have the same circuit structure and include the same elements as the switching circuit part SPC shown in FIGS. 2A and 2B.

In an embodiment, the first power supply voltage line PVL_H which transmits the second power supply voltage (e.g., ELVDD_H of FIGS. 2A and B) of the high level, the second power supply voltage line PVL_L which transmits the second power supply voltage (e.g., ELVDD_L of FIGS. 2A and B) of the low level, the gate line GL which transmits the gate signal (e.g., GS of FIGS. 2A and B), and the second data line DL_S which transmits the second data voltage (e.g., DATA2 of FIGS. 2A and B) may be electrically connected to the switching circuit part SPC.

In addition, in an embodiment, the switching circuit part SPC may be electrically connected to the pixel driving circuit parts PCa, PCb, and PCc (i.e., the pixel circuit block PCB) through the output power connection line PV_CL which selectively provides the second power supply voltage of the high level or the second power supply voltage of the low level.

For example, in an embodiment, each of the first power supply voltage line PVL_H, the second power supply voltage line PVL_L, and the second data line DL_S may extend in the second direction DR2. The second power supply voltage line PVL_L may be located between the first power supply voltage line PVL_H, and the second data line DL_S in the plan view. In addition, the output power connection line PV_CL may include a first portion extending in the second direction DR2 in an area where the switching circuit part SPC is disposed and a second portion extending in the first direction DR1 in an area where the first, second, and third pixel driving circuit parts PCa, PCb, and PCc are disposed. The output power connection line PV_CL may be located to a left of the first power supply voltage line PVL_H.

For example, in an embodiment, the output power connection line PV_CL may be connected to the switching circuit part SPC through a first contact hole CNT1_S, the first power supply voltage line PVL_H may be connected to the switching circuit part SPC through a second contact hole CNT2_S, the second power supply voltage line PVL_L may be connected to the switching circuit part SPC through a third contact hole CNT3_S, and the second data line DL_S may be connected to the switching circuit part SPC through a fourth contact hole CNT4_S. In addition, the output power connection line PV_CL may be connected to each of the pixel driving circuit parts PCa, PCb, and PCc through a contact hole CNT P.

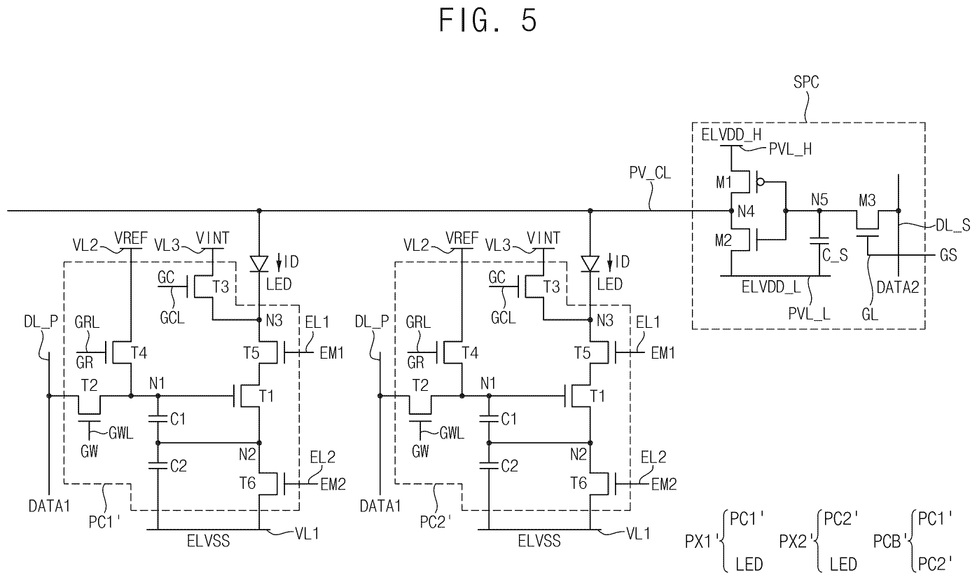

FIG. 5 is a circuit diagram illustrating an example of a circuit structure of a pixel and a switching circuit part included in the display device of FIGS. 1A and 1B, according to an embodiment.

Hereinafter, descriptions that overlap with those of the pixel and the switching circuit part described with reference to FIGS. 2A and 2B will be omitted or simplified.

In an embodiment and referring to FIG. 5, a first pixel PX1′ may include a first pixel driving circuit part PC1′ and a light-emitting element LED electrically connected to the first pixel driving circuit part PC1′, and a second pixel PX2′ may include a second pixel driving circuit PC2′ and the light-emitting element LED electrically connected to the second pixel driving circuit part PC2′.

In an embodiment, the first pixel driving circuit part PC1′ and the second pixel driving circuit part PC2′ may have substantially the same circuit structure.

In an embodiment, the first pixel driving circuit part PC1′ and the second pixel driving circuit part PC2′ may include a first transistor T1, a second transistor T2, a third transistor T3, a fourth transistor T4, a fifth transistor T5, a sixth transistor T6, a first capacitor C1, and a second capacitor C2.

In an embodiment, the first transistor T1, the second transistor T2, the third transistor T3, the fourth transistor T4, the fifth transistor T5, and the sixth transistor T6 may be all NMOS transistors. However, the invention is not necessarily limited thereto. For example, in another embodiment, the first transistor T1 may be an NMOS transistor. Some of the second transistor T2, the third transistor T3, the fourth transistor T4, the fifth transistor T5, and the sixth transistor T6 may be NMOS transistors, and others may be PMOS transistors.

In an embodiment, the first pixel driving circuit part PC1′ and the second pixel driving circuit part PC2′ may be electrically connected a first gate line GWL, a second gate line GCL, a third gate line GRL, a first data line DL_P, a first light-emitting control line EL1, a second light-emitting control line EL2, a first voltage line VL1, a second voltage line VL2, and a third voltage line VL3. The first gate line GWL may transmit a first gate signal GW. The second gate line GCL may transmit a second gate signal GC. The third gate line GRL may transmit a third gate signal GR. The first data line DL_P may transmit a first data voltage DATA1. The first light-emitting control line EL1 may transmit the first light-emitting control signal EM1. The second light-emitting control line EL2 may transmit the second light-emitting control signal EM2. The first voltage line VL1 may transmit a first power supply voltage ELVSS. The second voltage line VL2 may transmit a reference voltage VREF. The third voltage line VL3 may transmit an initialization voltage VINT.

In an embodiment, the first transistor T1 may include a gate electrode, a first electrode, and a second electrode. The gate electrode of the first transistor T1 may be connected to a first node N1. The first electrode of the first transistor T1 may be connected to a second node N2. The second electrode of the first transistor T1 may be connected to the first electrode (e.g., a source electrode) of the fifth transistor T5.

In an embodiment, the second transistor T2 may include a gate electrode, a first electrode, and a second electrode. The gate electrode of the second transistor T2 may be connected to the first gate line GWL and may receive the first gate signal GW. The first electrode of the second transistor T2 may be connected to the first node N1. The second electrode of the second transistor T2 may be connected to the first data line DL_P and may receive the first data voltage DATA1.

In an embodiment, the third transistor T3 may include a gate electrode, a first electrode, and a second electrode. The gate electrode of the third transistor T3 may be connected to the second gate line GCL and may receive the second gate signal GC. The first electrode of the third transistor T3 may be connected to a third node N3. The second electrode of the third transistor T3 may be connected to the third voltage line VL3 and may receive the initialization voltage VINT.

In an embodiment, the fourth transistor T4 may include a gate electrode, a first electrode, and a second electrode. The gate electrode of the fourth transistor T4 may be connected to the third gate line GRL and may receive the third gate signal GR. The first electrode of the fourth transistor T4 may be connected to the first electrode (e.g., a source electrode) of the second transistor T2. The second electrode of the fourth transistor T4 may be connected to the second voltage line VL2 and may receive the reference voltage VREF.

In an embodiment, the fifth transistor T5 may include a gate electrode, a first electrode, and a second electrode. The gate electrode of the fifth transistor T5 may be connected to the first light-emitting control line EL1 and may receive the first light-emitting control signal EM1. The first electrode of the fifth transistor T5 may be connected to the second electrode (e.g., a drain electrode) of the first transistor T1. The second electrode of the fifth transistor T5 may be connected to the third node N3.

In an embodiment, the sixth transistor T6 may include a gate electrode, a first electrode, and a second electrode. The gate electrode of the sixth transistor T6 may be connected to the second light-emitting control line EL2 and may receive the second emission control signal EM2. The first electrode of the sixth transistor T6 may be connected to the second node N2. The second electrode of the sixth transistor T6 may be connected to the first voltage line VL1 and may receive the first power supply voltage ELVSS.

In an embodiment, the first capacitor C1 may include a first electrode and a second electrode. The first electrode of the first capacitor C1 may be connected to the first node N1. The second electrode of the first capacitor C1 may be connected to the second electrode of the second capacitor C2.

In an embodiment, the second capacitor C2 may include a first electrode and a second electrode. The first electrode of the second capacitor C2 may be connected to the first voltage line VL1. The second electrode of the second capacitor C2 may be connected to the second electrode of the first capacitor C1.

In an embodiment, the light-emitting element LED may include an anode electrode and a cathode electrode. The cathode electrode of the light-emitting element LED may be connected to the third node N3. The anode electrode of the light-emitting element LED may be connected to the output power connection line PV_CL.

In an embodiment, the first electrode of each of the first transistor T1, the second transistor T2, the third transistor T3, the fourth transistor T4, the fifth transistor T5, and the sixth transistor T6 may be a source electrode, and the second electrode may be a drain electrode. However, the invention is not necessarily limited thereto.

In an embodiment, the display device DD may further include the switching circuit part SPC disposed in the display area DA and electrically connected to the pixel circuit block PCB′ including the pixel driving circuit parts PC1′ and PC2′. The switching circuit part SPC may selectively provide the second power supply voltage ELVDD_H of the high level or the second power supply voltage ELVDD_L of the low level to the pixel circuit block PCB′.

In an embodiment, the switching circuit part SPC may be electrically connected to the pixel driving circuit parts PC1′ and PC2′ through the output power connection line PV_CL. Specifically, the output power connection line PV_CL may connect the anode electrodes of the light-emitting elements LED of the pixel driving circuit parts PC1′ and PC2′, and the fourth node N4 of the switching circuit part SPC. Accordingly, the output power connection line PV_CL may selectively receive the second power supply voltage ELVDD_H of the high level or the second power supply voltage ELVDD_L of the low level.

In an embodiment, the switching circuit part SPC may include a first switching element M1, a second switching element M2, a third switching element M3, and a third capacitor C_S. The circuit structure of the switching circuit part SPC may be substantially the same as the circuit structure of the switching circuit part SPC shown in FIGS. 2A and 2B.

The number of pixel driving circuit parts of the pixel circuit block PCB′ connected to the switching circuit part SPC shown in FIG. 5 is an example of an embodiment, and the pixel circuit block PCB′ may include at least one pixel driving circuit part including a plurality of transistors.

In an embodiment, FIG. 5 shows that the pixel driving circuit part PC1′ and PC2′ of each pixel PX1′ and PX2′ includes six transistors and two capacitors, but the invention is not necessarily limited thereto. For example, in an embodiment, the pixel driving circuit part PC1′ and PC2′ of each pixel PX1′ and PX2′ may include two transistors and one capacitor. In this case, the driving transistor which generates the driving current may be an NMOS transistor.

In an embodiment and referring again to FIGS. 2A, 2B, 3, 4, and 5, the display device DD may include the plurality of pixel circuit blocks each including at least one pixel driving circuit part, and the switching circuit part SPC electrically connected one-to-one with the pixel circuit blocks and which selectively provides the second power supply voltage ELVDD_H of the high level or the second power supply voltage ELVDD_L of the low level. The plurality of transistors may include the driving transistor which generates the driving current ID and is an NMOS transistor. In this case, the second power supply voltage ELVDD_H of the high level may be applied to the pixel circuit blocks disposed in a high-brightness area of the display area DA, and the second power supply voltage ELVDD_L of the low level may be applied to the pixel circuit blocks disposed in a low-brightness area of the display area DA. Accordingly, a power consumption of the display device DD may be reduced.

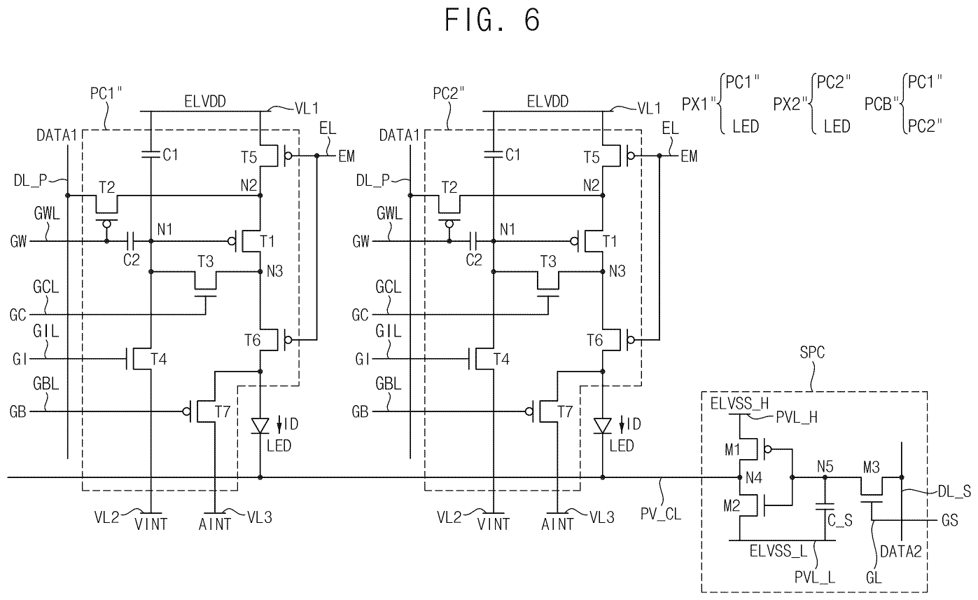

FIG. 6 is a circuit diagram illustrating an example of a circuit structure of a pixel and a switching circuit part included in the display device of FIGS. 1A and 1B, according to an embodiment.

Hereinafter, descriptions that overlap with those of the pixel and the switching circuit part described with reference to FIGS. 2A and 2B will be omitted or simplified.

In an embodiment and referring to FIG. 6, a first pixel PX1″ may include a first pixel driving circuit part PC1″ and a light-emitting element LED electrically connected to the first pixel driving circuit part PC1″, and a second pixel PX2″ may include a second pixel driving circuit part PC2″ and a light-emitting element LED electrically connected to the second pixel driving circuit part PC2″.

In an embodiment, the first pixel driving circuit part PC1″ and the second pixel driving circuit part PC2″ may have substantially the same circuit structure.

In an embodiment, each of the first pixel driving circuit part PC1″ and the second pixel driving circuit part PC2″ may include a first transistor T1, a second transistor T2, a third transistor T3, a fourth transistor T4, a fifth transistor T5, a sixth transistor T6, a seventh transistor T7, a first capacitor C1, and a second capacitor C2.

In an embodiment, each of the first transistor T1, the second transistor T2, the fifth transistor T5, the sixth transistor T6, and the seventh transistor T7 may be a PMOS transistor, and each of the third transistor T3 and the fourth transistor T4 may be an NMOS transistor. However, the invention is not necessarily limited thereto, and in another embodiment, the first transistor T1, the second transistor T2, the third transistor T3, the fourth transistor T4, the fifth transistor T5, the sixth transistor T6, and the seventh transistor T7 may all be PMOS transistors.

In an embodiment, each of the first pixel driving circuit part PC1″ and the second pixel driving circuit part PC2″ may be electrically connected to a first gate line GWL, a second gate line GCL, a third gate line GIL, a fourth gate line GBL, a first data line DL_P, a light-emitting control line EL, a first voltage line VL1, a second voltage line VL2, and a third voltage line VL3. The first gate line GWL may transmit a first gate signal GW. The second gate line GCL may transmit a second gate signal GC. The third gate line GIL may transmit a third gate signal GI. The fourth gate line GBL may transmit a fourth gate signal GB. The first data line DL_P may transmit a first data voltage DATA1. The light-emitting control line EL may transmit a light-emitting control signal EM. The first voltage line VL1 may transmit a second power supply voltage ELVDD. The second voltage line VL2 may transmit a first initialization voltage VINT. The third voltage line VL3 may transmit a second initialization voltage AlNT.

In an embodiment, the first transistor T1 may include a gate electrode, a first electrode, and a second electrode. The gate electrode of the first transistor T1 may be connected to a first node N1. The first electrode of the first transistor T1 may be connected to a second node N2. The second electrode of the first transistor T1 may be connected to a third node N3. The first transistor T1 may be referred to as a driving transistor.

In an embodiment, the second transistor T2 may include a gate electrode, a first electrode, and a second electrode. The gate electrode of the second transistor T2 may be connected to the first gate line GWL and may receive the first gate signal GW. The first electrode of the second transistor T2 may be connected to the first data line DL_P and may receive the first data voltage DATA1. The second electrode of the second transistor T2 may be connected to the second node N2.

In an embodiment, the third transistor T3 may include a gate electrode, a first electrode, and a second electrode. The gate electrode of the third transistor T3 may be connected to the second gate line GCL and may receive the second gate signal GC. The first electrode of the third transistor T3 may be connected to the third node N3. The second electrode of the third transistor T3 may be connected to the first node N1.

In an embodiment, the fourth transistor T4 may include a gate electrode, a first electrode, and a second electrode. The gate electrode of the fourth transistor T4 may be connected to the third gate line GIL and can receive the third gate signal GI. The first electrode of the fourth transistor T4 may be connected to the second electrode of the third transistor T3. The second electrode of the fourth transistor T4 may be connected to the second voltage line VL2 and may receive the first initialization voltage VINT.

In an embodiment, the fifth transistor T5 may include a gate electrode, a first electrode, and a second electrode. The gate electrode of the fifth transistor T5 may be connected to the emission control line EL and may receive the light-emitting control signal EM. The first electrode of the fifth transistor T5 may be connected to the first voltage line VL1 and may receive the second power supply voltage ELVDD. The second electrode of the fifth transistor T5 may be connected to the second node N2.

In an embodiment, the sixth transistor T6 may include a gate electrode, a first electrode, and a second electrode. The gate electrode of the sixth transistor T6 may be connected to the emission control line EL and may receive the emission control signal EM. The first electrode of the sixth transistor T6 may be connected to the third node N3. The second electrode of the sixth transistor T6 may be connected to the second electrode of the seventh transistor T7.

In an embodiment and as shown in FIG. 6, a single light-emitting control line EL may be connected to the gate electrode of the fifth transistor T5 and the gate electrode of the sixth transistor T6. In another embodiment, a light-emitting control line connected to the gate electrode of the fifth transistor T5 and a light-emitting control line connected to the gate electrode of the sixth transistor T6 may be independent from each other.

In an embodiment, the seventh transistor T7 may include a gate electrode, a first electrode, and a second electrode. The gate electrode of the seventh transistor T7 may be connected to the fourth gate line GBL and may receive the fourth gate signal GB. The first electrode of the seventh transistor T7 may be connected to the third voltage line VL3 and may receive the second initialization voltage AlNT. The second electrode of the seventh transistor T7 may be connected to the anode electrode of the light-emitting element LED.

In an embodiment, the first capacitor C1 may include a first electrode and a second electrode. The first electrode of the first capacitor C1 may be connected to the first voltage line VL1 and may receive the second power supply voltage ELVDD. The second electrode of the first capacitor C1 may be connected to the first node N1.

In an embodiment, the second capacitor C2 may include a first electrode and a second electrode. The first electrode of the second capacitor C2 may be connected to the gate electrode of the second transistor T2. The second electrode of the second capacitor C2 may be connected to the first node N1.

In an embodiment, the light-emitting element LED may include an anode electrode and a cathode electrode. The anode electrode of the light-emitting element LED may be connected to the second electrode of the seventh transistor T7. The cathode electrode of the light-emitting element LED may be connected to the output power connection line PV_CL.

In an embodiment, the first electrode of each of the first transistor T1, the second transistor T2, the third transistor T3, the fourth transistor T4, the fifth transistor T5, the sixth transistor T6, and the seventh transistor T7 may be a source electrode, and the second electrode may be a drain electrode. However, the invention is not necessarily limited thereto.

In an embodiment, the display device DD may further include the switching circuit part SPC disposed in the display area DA and electrically connected to a pixel circuit block PCB″ including the first and second driving circuit parts PC1″ and PC2″, respectively. The switching circuit part SPC may selectively provide a first power supply voltage ELVSS_H of a high level or a first power supply voltage ELVSS_L of a low level to the pixel circuit block PCB″.

In an embodiment, the switching circuit part SPC may be electrically connected to the pixel driving circuit parts PC1″ and PC2″ through the output power connection line PV_CL. Specifically, the output power connection line PV_CL may connect to the cathode electrode of the light-emitting elements LED of the pixel driving circuit parts PC1″ and PC2″ and the fourth node N4 of the switching circuit part SPC. Accordingly, the output power connection line PV_CL may selectively receive the first power supply voltage ELVSS_H of the high level or the first power supply voltage ELVSS_L of the low level.

In an embodiment, the switching circuit part SPC may include a first switching element M1, a second switching element M2, a third switching element M3, and a third capacitor C_S. The circuit structure of the switching circuit part SPC may be substantially the same as the circuit structure of the switching circuit part SPC shown in FIGS. 2A and 2B.

For example, in an embodiment, each of the first power supply voltage ELVSS_H of the high level and the first power supply voltage ELVSS_L of the low level may be a common voltage having a lower voltage level than the second power supply voltage ELVDD. In this case, the second power supply voltage ELVDD may be referred to as a driving voltage.

For example, in an embodiment, when the gate signal GS has an activation level, the third switching element M3 may be turned on. In this case, the third switching element M3 may provide a second data voltage DATA2 of a first voltage level or a second data voltage DATA2 of a second voltage level different from the first voltage level to the gate electrode of the first switching element M1 and the gate electrode of the second switching element M2 through the second data line DL_S.

For example, in an embodiment, when the first switching element M1 is a PMOS transistor and the second switching element M2 is an NMOS transistor, the first voltage level may be a low level and the second voltage level may be a high level.

In an embodiment, the third switching element M3 provides the second data voltage DATA2 of the first voltage level to the gate electrode of the first switching element M1 and the gate electrode of the second switching element M2, the first switching element M1 may be turned on and the second switching element M2 may be turned off. In this case, the first switching element M1 may provide the first power supply voltage ELVSS_H of the high level to the output power connection line PV_CL. Accordingly, the output power connection line PV_CL may transmit the first power supply voltage ELVSS_H of the high level to the pixel circuit block PCB″ including the pixel driving circuit parts PC1″ and PC2″.

In an embodiment, the third switching element M3 provides the second data voltage DATA2 of the second voltage level to the gate electrode of the first switching element M1 and the gate electrode of the second switching element M2, the first switching element M1 may be turned off and the second switching element M2 may be turned on. In this case, the first switching element M1 may provide the first power supply voltage ELVSS_L of the low level to the output power connection line PV_CL. Accordingly, the output power connection line PV_CL may transmit the first power supply voltage ELVSS_L of the low level to the pixel circuit block PCB″ including the pixel driving circuit parts PC1″ and PC2″.

In an embodiment, the number of pixel driving circuit parts of the pixel circuit block PCB″ connected to the switching circuit part SPC shown in FIG. 6 is an example, and the pixel circuit block PCB″ may include at least one pixel driving circuit part including a plurality of transistors.

In an embodiment, FIG. 6 shows that the pixel driving circuit part PC1″ and PC2″ of each pixel PX1″ and PX2″ includes seven transistors and two capacitors, but the invention is not necessarily limited thereto.

For example, in an embodiment, the pixel driving circuit part PC1″ and PC2″ of each pixel PX1″ and PX2″ may include at least one transistor and at least one capacitor. In this case, the driving transistor which generates the driving current may be a PMOS transistor.

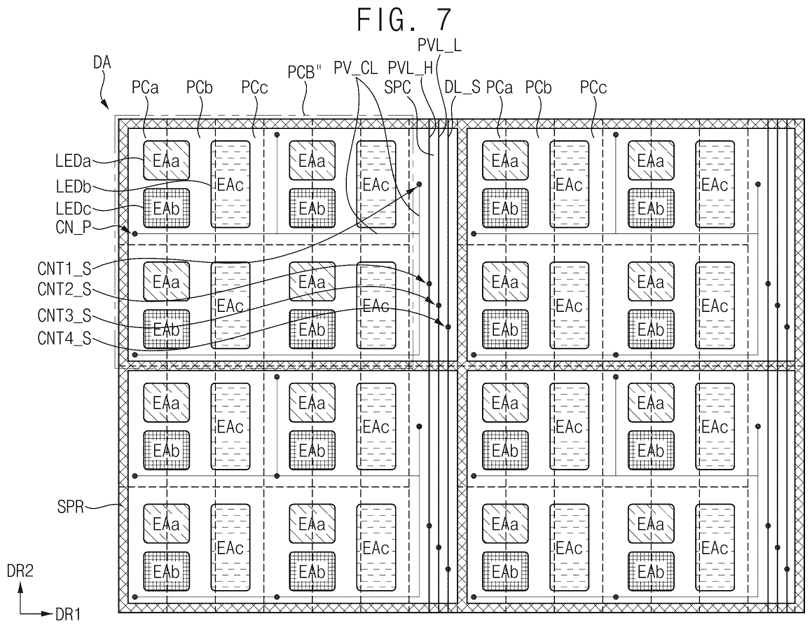

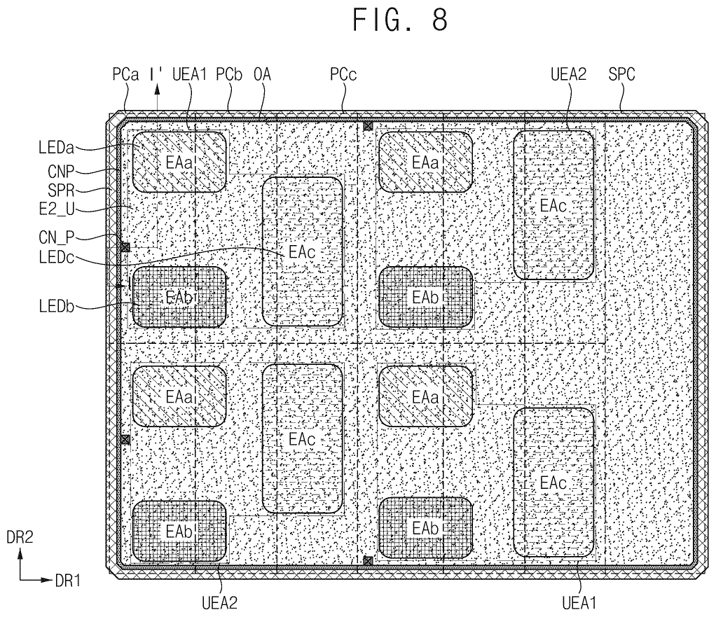

FIG. 7 is a plan view schematically showing a portion of a display area of FIGS. 1A and 1B, according to an embodiment. FIG. 8 is an enlarged plan view of one pixel circuit block, light emitting elements connected to the one pixel circuit block, and one switching circuit part of FIG. 7, according to an embodiment.

Hereinafter, descriptions that overlap with those described with reference to FIGS. 3 and 4 will be omitted or simplified.

In an embodiment and referring to FIGS. 7 and 8, the display device DD may include the pixel driving parts PCa, PCb, and PCc, the light-emitting elements LEDa, LEDb, and LEDc, the switching circuit part SPC, a plurality of connection patterns CNP, and a separator SPR disposed in the display area DA.

In an embodiment, the pixel driving circuit parts PCa, PCb, and PCc may correspond to the pixel driving circuit parts PC1″ and PC2″ shown in FIG. 6, respectively. That is, the pixel driving circuit parts PCa, PCb, and PCc have the same circuit structure as the pixel driving circuit units PC1″ and PC2″ shown in FIG. 6 and may include the same elements, respectively.

In an embodiment, each of the light-emitting elements LEDa, LEDb, and LEDc may correspond to the light-emitting element LED shown in FIG. 6. The display area DA may include light-emitting areas EAa, EAb, and EAc. The first light-emitting element LEDa may be disposed in the first light-emitting area EAa, the second light-emitting element LEDb may be disposed in the second light-emitting area EAb, and the third light-emitting element LEDc may be disposed in the third light-emitting area EAc.

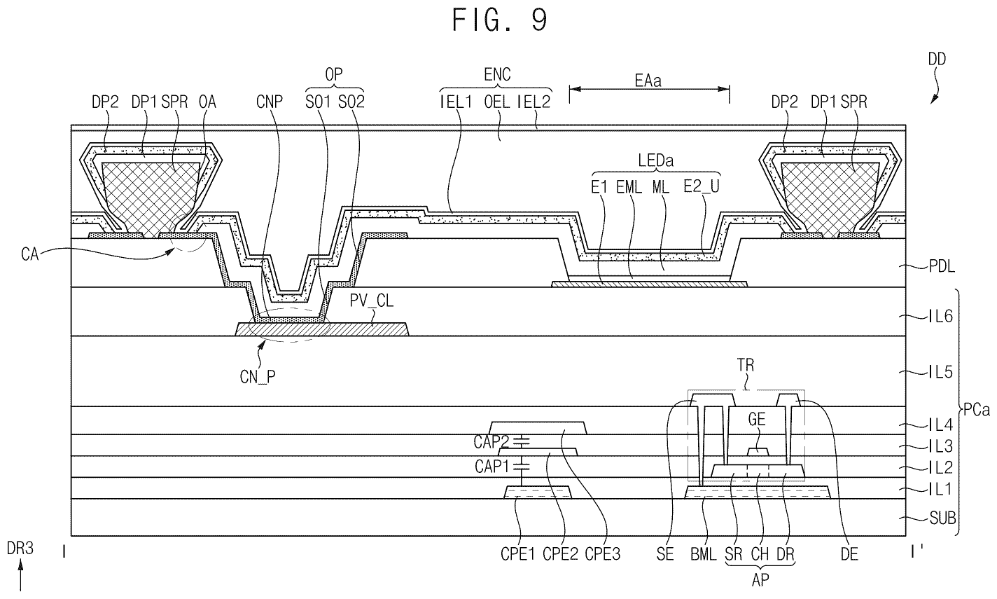

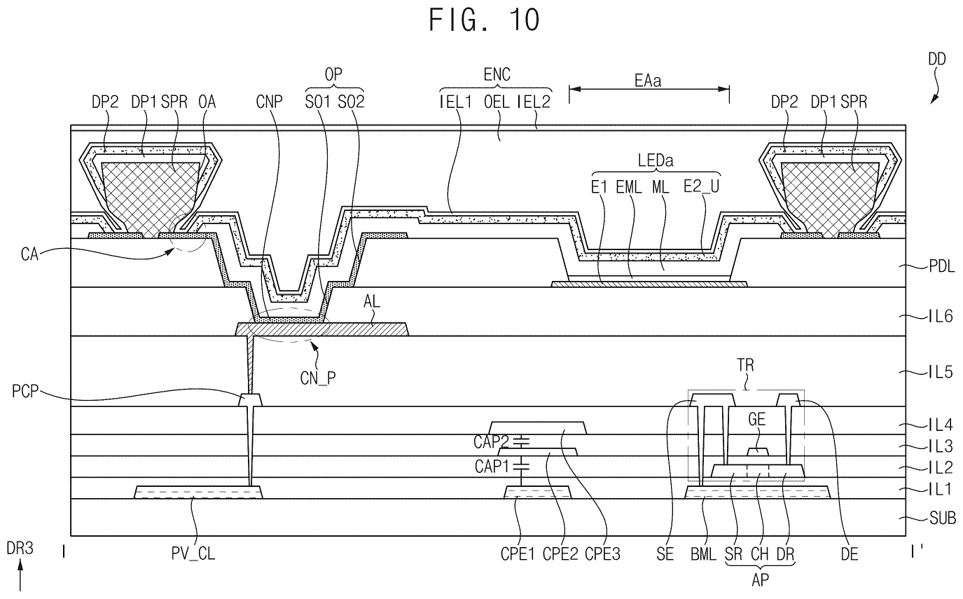

In an embodiment, each of the light-emitting elements LEDa, LEDb, and LEDc may include a first electrode (e.g., a first electrode E1 of FIGS. 9 and 10), a light-emitting layer (e.g., a light-emitting layer EML of FIGS. 9 and 10) disposed on the first electrode, a middle layer (e.g., a middle layer ML of FIGS. 9 and 10) disposed on the light emitting layer, and second electrode layer disposed on the middle layer. In an embodiment, the first electrode may be an anode electrode, and the second electrode layer may be a cathode electrode.

In an embodiment, in the display area DA, a first unit light-emitting area UEA1 including the light-emitting areas EAa, EAb, and EAc and a second unit light-emitting area UEA2 including the light-emitting areas EAa, EAb, and EAc may be defined.

For example, in an embodiment, the first unit light-emitting area UEA1 and the second unit light-emitting area UEA2 may be distinguished based on the arrangement relationship between the light-emitting elements LEDa, LEDb, and LEDc (or, the arrangement relationship between the light-emitting areas EAa, EAb, and EAc). That is, the arrangement relationship between the light emitting-elements LEDa, LEDb, and LEDc (or, the light-emitting areas EAa, EAb, and EAc) in each first unit light-emitting area UEA1 may be substantially the same, and the arrangement relationship between the light emitting-elements LEDa, LEDb, and LEDc (or, the light-emitting areas EAa, EAb, and EAc) in each second unit light-emitting area UEA2 may be substantially the same.

For example, in an embodiment, the first unit light-emitting area UEA1 and the second unit light-emitting area UEA2 may be alternately arranged along the first direction DR1 and the second direction DR2. However, the invention is not necessarily limited to this, and the number of different unit light-emitting areas or the arrangement relationship between the unit light-emitting areas may vary depending on the embodiments.

In an embodiment, the pixel circuit block PCB″ may include a plurality of pixel driving circuit parts. For example, the pixel circuit block PCB″ may include four first pixel driving circuit parts PCa, four second pixel driving circuit parts PCb, and four third pixel driving circuit parts PCc. However, the invention is not limited to this, and the number of pixel driving circuit parts included in the pixel circuit block PCB″ may vary.

In an embodiment, the switching circuit part SPC may correspond to the switching circuit part SPC shown in FIG. 6. That is, the switching circuit part SPC may have the same circuit structure and include the same elements as the switching circuit part SPC shown in FIG. 6.

In an embodiment, the first power supply voltage line PVL_H which transmits the first power supply voltage (e.g., ELVSS_H of FIG. 6) of the high level, the second power supply voltage line PVL_L which transmits the first power supply voltage (e.g., ELVSS_L of FIG. 6) of the low level, the gate line GL which transmits a gate signal (e.g., GS of FIG. 6), and the second data line DL_S which transmits a second data voltage (e.g., DATA2 of FIG. 6) may be electrically connected to the switching circuit part SPC.

In an embodiment, the switching circuit part SPC may be electrically connected to the pixel driving circuit parts PCa, PCb, and PCc (i.e., the pixel circuit block PCB″) through the output power connection line PV_CL which selectively provides the first power supply voltage of the high level or the first power supply voltage of the low level.

In an embodiment, the separator SPR may include an organic insulating material. The separator SPR may include a photosensitive resin (e.g., a photoresist). However, the invention is not necessarily limited thereto.

In an embodiment, the separator SPR may have a mesh structure surrounding the pixel circuit blocks PCB″ and the switching circuit part SPC in the plan view. Specifically, the separator SPR may be disposed between adjacent pixel circuit blocks PCB″, and may be disposed between the switching circuit part SPC and the pixel circuit block PCB″ adjacent to the switching circuit part SPC in the first direction DR1.

In an embodiment, the second electrode layer of the light-emitting elements LEDa, LEDb, and LEDc may be separated (or disconnected) by the separator SPR. Accordingly, the second electrode layer may be separated (or disconnected) into a plurality of unit electrodes E2_U spaced apart from each other by the separator SPR. Each of the unit electrodes E2_U may be disposed on the pixel circuit block PCB″. That is, one unit electrode E2_U may be disposed on one pixel circuit block PCB″. The unit electrodes E2_U may be electrically independent from each other.

In an embodiment, the separator SPR may define an open area OA corresponding to the unit electrodes E2_U. Each of the unit electrodes E2_U may be disposed in the open area OA. For example, a planar shape of each of the unit electrodes E2_U may be substantially the same as a planar shape of the open area OA.

For example, in an embodiment, the output power connection line PV_CL may be connected to the switching circuit part SPC through a first contact hole CNT1_S, the first power supply voltage line PVL_H may be connected to the switching circuit part SPC through a second contact hole CNT2_S, the second power supply voltage line PVL_L may be connected to the switching circuit part SPC through a third contact hole CNT3_S, and the second data line DL_S may be connected to the switching circuit part SPC through a fourth contact hole CNT4_S.

In an embodiment, each of the connection patterns CNP may be disposed to correspond to each pixel circuit block PCB″ and each switching circuit part SPC in the plan view. In an embodiment, the output power connection line PV_CL may be connected to the first, second, and third light emitting-elements LEDa, LEDb, and LEDc through the connection patterns CNP.

In an embodiment, the connection patterns CNP may include transparent conductive oxide. Examples of the transparent conductive oxides that can be used as the connection patterns CNP may include indium gallium zinc oxide (IGZO), indium tin zinc oxide (ITZO), indium tin oxide (ITO), indium zinc oxide (IZO), indium gallium oxide. (IGO), zinc oxide (ZnO), indium oxide (InO), tin oxide (SnO), gallium oxide (GaO), aluminum zinc oxide (AZO), and the like. These can be used alone or in combination with each other.

However, the invention is not necessarily limited thereto, and the connection patterns CNP may include a conductive material such as a metal, alloy, conductive metal nitride, and the like. Examples of the conductive materials that can be used as the connection patterns CNP may include gold (Au), silver (Ag), aluminum (Al), platinum (Pt), nickel (Ni), titanium (Ti), palladium (Pd), magnesium (Mg), calcium (Ca), lithium (Li), chromium (Cr), tantalum (Ta), tungsten (W), copper (Cu), molybdenum (Mo), scandium (Sc), neodymium (Nd), iridium (Ir), alloy containing aluminum (Al), alloy containing silver (Ag), alloy containing copper (Cu), alloy containing molybdenum (Mo), aluminum nitride (AlN), tungsten nitride (WN), titanium nitride (TiN), chromium nitride (CrN), tantalum nitride (TaN), and the like.

In an embodiment, each of the connection patterns CNP may have a single-layer structure or a multi-layer structure in which a plurality of conductive layers are stacked.

In an embodiment, the connection patterns CNP may not overlap the light-emitting areas EAa, EAb, and EAc in the plan view. That is, the connection patterns CNP may be spaced apart from the light-emitting areas EAa, EAb, and EAc in the plan view.

In an embodiment, in each area where one pixel circuit block PCB″ and one switching circuit part SPC are disposed, each of the connection patterns CNP may have a shape surrounding at least a portion of the light-emitting areas EAa, EAb, and EAc. For example, in each area where one pixel circuit block PCB″ and one switching circuit part SPC are disposed, each of the connection patterns CNP may have a closed ring shape entirely surrounding the light-emitting areas EAa, EAb, and EAc.

In an embodiment, in each area where one pixel circuit block PCB″ and one switching circuit part SPC are disposed, the output power connection line PV_C may be connected to the unit electrode E2_U of the light-emitting elements LEDa, LEDb, and LEDc through the connection pattern CNP. For example, the connection pattern CNP may contact the output power connection line PV_CL and the unit electrode E2_U of the light emitting elements LEDa, LEDb, and LEDc. Accordingly, the output power connection line PV_CL may be electrically connected to the pixel circuit block PCB″. As a result, the switching circuit part SPC may be electrically connected to the pixel circuit block PCB″ through the output power connection line PV_CL.

In an embodiment, the output power connection line PV_CL may include a light-emitting connection portion CN_P contacting the connection pattern CNP. In an embodiment, there may be at least one light-emitting connection portion CN_P each pixel circuit block PCB″ (i.e., one unit electrode E2_U). For example, as shown in FIGS. 7 and 8, there may be four light-emitting connection portions CN_P each one pixel circuit block PCB″ (i.e., one unit electrode E2_U). However, the invention is not necessarily limited thereto.

For example, in an embodiment, the position of the light-emitting connection portion CN_P for each pixel circuit block PCB″ (i.e., unit electrodes E2_U) may be substantially the same. However, the invention is not necessarily limited thereto.

In an embodiment, in each area where one pixel circuit block PCB″ is disposed, a planar profile of an area (e.g., a contact area CA of FIGS. 9 and 10) where the unit electrode E2_U and the connection pattern CNP contact may be substantially the same as or similar to a planar profile of an edge of the connection pattern CNP. For example, if the connection pattern CNP has a closed ring shape entirely surrounding the pixel circuit block PCB″ in the plan view, the area where the unit electrode E2_U and the connection pattern CNP contact may have a closed ring shape in the plan view.

In an embodiment, the separator SPR may overlap the connection patterns CNP in the plan view. Specifically, the separator SPR may cover a portion of the connection patterns CNP and may be disposed between adjacent connection patterns CNP. That is, at least a portion of the separator SPR may extend along the edges of each of the connection patterns CNP in the plan view. Accordingly, the areas (e.g., the contact area CA of FIGS. 9 and 10) where the unit electrodes E2_U and the connection patterns CNP contact may partially overlap an area where the separator SPR is disposed in the plan view.

FIG. 9 is a cross-sectional view showing an example of a cross-section taken along line I-I′ of FIG. 8, according to an embodiment. FIG. 10 is a cross-sectional view showing an example of a cross-section taken along line I-I′ of FIG. 8, according to an embodiment.

For example, FIG. 9 is a cross-sectional view showing the cross-sectional structure of an embodiment of the display device DD centered on the first light-emitting area EAa. The following description regarding the cross-sectional structure of the display device DD may be equally applied to all light-emitting areas.

Hereinafter, content that overlaps with the content described with reference to FIG. 8 will be omitted or simplified.

In an embodiment and referring to FIGS. 9 and 10, the display device DD may include a substrate SUB, a transistor TR, a first capacitor CAP1, a second capacitor CAP2, first, second, third, fourth, fifth, and sixth insulating layers IL1, IL2, IL3, IL4, IL5, and IL6, respectively, the output power connection line PV_CL, the connection pattern CNP, a pixel defining layer PDL, the first light-emitting element LEDa, the separator SPR, a first dummy layer DP1, a second dummy layer DP2, and an encapsulation layer ENC sequentially disposed in the third direction DR3. For example, the third direction DR3 may be directed perpendicular to the plane defined by the first direction DR1 and the second direction DR2 of FIGS. 1A and 1B.

Here, in an embodiment, the substrate SUB, the transistor TR, the first capacitor CAP1, the second capacitor CAP2 and the insulating layers IL1, IL2, IL3, IL4, IL5, and IL6 may be components of the pixel driving circuit part PCa.

In an embodiment, the transistor TR may include an active pattern AP, a gate electrode GE, a first contact electrode SE, and a second contact electrode DE. The first capacitor CAP1 may include a first capacitor electrode CPE1 and a second capacitor electrode CPE2. The second capacitor CAP2 may include a second capacitor electrode CPE2 and a third capacitor electrode CPE3. The first light-emitting element LEDa may include the first electrode E1, the light-emitting layer EML, the middle layer ML, and the unit electrode E2_U.

In an embodiment, the transistor TR, the first capacitor CAP1, and the second capacitor CAP2 may be components included in the first pixel driving circuit part PCa. For example, the transistor TR may correspond to the sixth transistor T6 or the seventh transistor T7 of FIG. 6, and the second capacitor CAP2 may correspond to the first capacitor C1 of FIG. 6, and the first capacitor CAP1 may correspond to the second capacitor C2 of FIG. 6.

In an embodiment, the first capacitor electrode CPE1 and a lower conductive layer BML may be disposed on the substrate SUB. For example, the first capacitor electrode CPE1 and the lower conductive layer BML may include metal, alloy, conductive metal oxide, conductive metal nitride, transparent conductive oxide, and the like. These can be used alone or in combination with each other. The first capacitor electrode CPE1 and the lower conductive layer BML may include the same material and be disposed in the same layer.

In an embodiment, the first insulating layer IL1 may be disposed on the substrate SUB to cover the first capacitor electrode CPE1 and the lower conductive layer BML. The first insulating layer IL1 may prevent metal atoms or impurities from diffusing from the substrate SUB to the transistor TR. For example, the first insulating layer IL1 may include an insulating material such as silicon oxide, silicon nitride, silicon oxynitride, and the like. These can be used alone or in combination with each other.

In an embodiment, the active pattern AP may be disposed on the first insulating layer IL1. In an embodiment, the active pattern AP may overlap the lower conductive layer BML in the plan view. The active pattern AP may include a metal oxide semiconductor, a silicon semiconductor, and/or an organic semiconductor. The active pattern AP may include a first contact region SR, a second contact region DR, and a channel region CH between the first contact region SR and the second contact region DR. The first contact region SR and the second contact region DR may have higher conductivity than the channel region CH.

In an embodiment, the active pattern AP may include a silicon semiconductor such as polysilicon. However, the invention is not necessarily limited thereto.

In an embodiment, the second insulating layer IL2 may be disposed on the first insulating layer IL1 to cover the active pattern AP. For example, the second insulating layer IL2 may include an insulating material such as silicon oxide, silicon nitride, silicon oxynitride, and the like. These can be used alone or in combination with each other.

In an embodiment, the gate electrode GE may be disposed on the second insulating layer IL2. The gate electrode GE may overlap the channel region CH of the active pattern AP. For example, the gate electrode GE may include metal, alloy, conductive metal oxide, conductive metal nitride, transparent conductive oxide, and the like. These can be used alone or in combination with each other.

For example, in an embodiment, the gate electrode GE may contact the lower conductive layer BML. In this case, the first contact electrode SE may not contact the lower conductive layer BML.

In an embodiment, the second capacitor electrode CPE2 may be disposed on the second insulating layer IL2. The first capacitor electrode CPE1 may overlap the second capacitor electrode CPE2 in the plan view. The first capacitor electrode CPE1 and the second capacitor electrode CPE2 may form the first capacitor CAP1. For example, the second capacitor electrode CPE2 may include metal, alloy, conductive metal oxide, conductive metal nitride, transparent conductive oxide, and the like. These can be used alone or in combination with each other.

In an embodiment, the gate electrode GE and the second capacitor electrode CPE2 may include the same material and be disposed in the same layer.

In an embodiment, the third insulating layer IL3 may be disposed on the second insulating layer IL2 to cover the gate electrode GE and the second capacitor electrode CPE2. For example, the third insulating layer IL3 may include an insulating material such as silicon oxide, silicon nitride, silicon oxynitride, and the like. These can be used alone or in combination with each other.

In an embodiment, the third capacitor electrode CPE3 may be disposed on the third insulating layer IL3. The third capacitor electrode CPE3 may overlap the second capacitor electrode CPE2. The second capacitor electrode CPE2 and the third capacitor electrode CPE3 may form the second capacitor CAP2. For example, the third capacitor electrode CPE3 may include metal, alloy, conductive metal oxide, conductive metal nitride, transparent conductive oxide, and the like. These can be used alone or in combination with each other.

In an embodiment, the fourth insulating layer IL4 may be disposed on the third insulating layer IL3 to cover the third capacitor electrode CPE3. For example, the fourth insulating layer IL4 may include an insulating material such as silicon oxide, silicon nitride, silicon oxynitride, and the like. These can be used alone or in combination with each other.

In an embodiment, the contact electrodes SE and DE may be disposed on the fourth insulating layer IL4. The first contact electrode SE may contact the first contact area SR of the active pattern AP, and the second contact electrode DE may contact the second contact area DR of the active pattern AP. For example, the contact electrodes SE and DE may include metal, alloy, conductive metal oxide, conductive metal nitride, transparent conductive oxide, and the like. These can be used alone or in combination with each other. The contact electrodes SE and DE may include the same material and be disposed in the same layer.

In an embodiment, the first contact electrode SE may contact the lower conductive layer BML. However, the invention is not necessarily limited thereto. For example, when the gate electrode GE contacts the lower conductive layer BML, the first contact electrode SE may not contact the lower conductive layer BML.

In an embodiment, the fifth insulating layer IL5 may be disposed on the fourth insulating layer IL4 to cover the contact electrodes SE and DE. For example, the fifth insulating layer IL5 may include an organic insulating material. Examples of the organic insulating material that can be used as the fifth insulating layer IL5 may include photoresist, polyacryl-based resin, polyimide-based resin, polyamide-based resin, siloxane-based resin, acryl-based resin, epoxy-based resin, and the like. These can be used alone or in combination with each other.

In an embodiment, as shown in FIG. 9, the output power connection line PV_CL may be disposed on the fifth insulating layer IL5. In this case, the output power connection line PV_CL may directly contact the connection pattern CNP. The output power connection line PV_CL may include the light-emitting connection portion CN_P contacting the connection pattern CNP.

In another embodiment, as shown in FIG. 10, the output connection line PV_CL may be disposed in the same layer as the lower conductive layer BML. In this case, the output connection line PV_CL may be connected to the connection pattern CNP through a pixel connection pattern PCP and an auxiliary line AL. The pixel connection pattern PCP may be disposed in the same layer as the contact electrodes SE and DE, and the auxiliary line AL may be disposed on the fifth insulating layer IL5. The auxiliary line AL may directly contact the connection pattern CNP. In addition, the auxiliary line AL may include a light-emitting connection portion CN_P contacting the connection pattern CNP.

In an embodiment, the sixth insulating layer IL6 may partially cover the output power connection line PV_CL of FIG. 9 or the auxiliary line AL of FIG. 10 and may be disposed on the fifth insulating layer IL5. The sixth insulating layer IL6 may define a first sub-opening SO1 exposing at least a portion of the output power connection line PV_CL of FIG. 9 or the auxiliary line AL of FIG. 10. For example, the sixth insulating layer IL6 may include an organic insulating material. Examples of the organic insulating material that can be used as the sixth insulating layer IL6 may include photoresist, polyacryl-based resin, polyimide-based resin, polyamide-based resin, siloxane-based resin, acryl-based resin, epoxy-based resin, and the like. These can be used alone or in combination with each other.

In this specification, each of the insulating layers IL1, IL2, IL3, and IL4 may be referred to as an inorganic insulating layer, and each of the insulating layers IL5 and IL6 may be referred to as an organic insulating layer.

In an embodiment, the first electrode E1 may be disposed on the sixth insulating layer IL6. The first electrode E1 may overlap the first light-emitting area EAa. For example, the first electrode E1 may include metal, alloy, conductive metal oxide, conductive metal nitride, transparent conductive oxide, and the like. These can be used alone or in combination with each other.

In an embodiment, the pixel defining layer PDL may be disposed on the sixth insulating layer IL6 and the first electrode E1. The pixel defining layer PDL may define a pixel opening exposing at least a portion of the first electrode E1. The first light-emitting area EAa may be defined by the pixel opening. For example, the pixel defining layer PDL may include an organic insulating material or an inorganic insulating material.

In an embodiment, the pixel defining layer PDL may further define a second sub-opening SO2 corresponding to the first sub-opening SO1 of the sixth insulating layer IL6. The second sub-opening SO2 may overlap the first sub-opening SO1 in the plan view, and the first sub-opening SO1 and the second sub-opening SO2 may be spatially connected to each other. That is, an opening OP connected to the first sub-opening SO1 and the second sub-opening SO2 may be defined, and the opening OP may expose at least a portion of the output power connection line PV_CL of FIG. 9 or the auxiliary line AL of FIG. 10.

In an embodiment, the connection pattern CNP may be disposed on the sixth insulating layer IL6 and the pixel defining layer PDL. The connection pattern CNP may contact the output power connection line PV_CL of FIG. 9 or the auxiliary line AL of FIG. 10 through the opening OP of the sixth insulating layer IL6 and the pixel defining layer PDL. Accordingly, the light-emitting connection portion CN_P may be exposed through the opening OP.

In an embodiment, the separator SPR may be disposed on the pixel defining layer PDL and the connection pattern CNP. The separator SPR may overlap the connection pattern CNP in the plan view. For example, the separator SPR may cover a portion of the connection pattern CNP.

In an embodiment, the separator SPR may have a shape where an upper width is larger than a lower width. That is, a side surface of the separator SPR connecting an upper surface of the separator SPR and a lower surface of the separator SPR may have a reverse tapered slope. That is, the cross-section of at least a portion of the separator SPR may be a truncated trapezoidal.

In an embodiment, the side surface of the separator SPR may have a plurality of reverse tapered slopes. That is, the separator SPR may have a double reverse tapered structure. Accordingly, separation (or disconnection) of the second electrode layer by the separator SPR may be more easily implemented.

In an embodiment, the light-emitting layer EML may be disposed on the first electrode E1. Specifically, the light-emitting layer EML may be disposed in the pixel opening. For example, the light-emitting layer EML may include a light-emitting material which produces light of a specific color (e.g., red, green, or blue).

In an embodiment, the middle layer ML may be disposed on the first electrode E1, the pixel defining layer PDL, and the connection pattern CNP. Specifically, the middle layer ML may be disposed in the open area OA of the separator SPR. For example, the middle layer ML may include a hole injection layer, a hole transport layer, an electron transport layer, an electron injection layer, and the like.

In an embodiment, there may be a shadow area around the separator SPR having a reverse tapered slope where it is difficult to deposit the middle layer ML. Accordingly, the middle layer ML in the shadow area and/or around the shadow area may have a structure separated (or disconnected) by the separator SPR.

In an embodiment, as the middle layer ML has a separated (or disconnected) structure, the middle layer ML may not entirely cover the connection pattern CNP. That is, the middle layer ML may expose at least a portion of the connection pattern CNP disposed at a position adjacent to or overlapping the separator SPR. Accordingly, the unit electrode E2_U of the first light-emitting element LEDa may contact the connection pattern CNP.

In an embodiment, the first dummy layer DP1 may be disposed on the separator SPR. The first dummy layer DP1 may be formed by having a structure in which the middle layer ML is separated (or disconnected) by the separator SPR. That is, the first dummy layer DP1 may be formed through the same process as the middle layer ML. In another embodiment, the first dummy layer DP1 may be omitted.

In an embodiment, the unit electrode E2_U may be disposed on the middle layer ML. For example, the unit electrode E2_U may include metal, alloy, conductive metal oxide, conductive metal nitride, transparent conductive oxide, and the like. These can be used alone or in combination with each other.

In an embodiment, the unit electrode E2_U may have a single-layer structure. However, the invention is not necessarily limited to this, and the unit electrode E2_U may have a multilayer structure in which a plurality of conductive layers are stacked. For example, the unit electrode E2_U may have a two-layer structure in which a first sub-electrode layer including a metal material a second sub-electrode layer disposed on the first sub-electrode layer and including a transparent conductive oxide are stacked.

In an embodiment, there may be a shadow area around the separator SPR having a reverse tapered slope where it is difficult to deposit the second electrode layer. Accordingly, the second electrode layer in the shadow area and/or around the shadow area may have a structure separated (or disconnected) by the separator SPR. For example, the second electrode layer may be separated (or disconnected) into the unit electrodes E2_U of the first, second, and third light-emitting elements LEDa, LEDb, and LEDc of FIGS. 7 and 8 respectively disposed in the open areas OA of the separator SPR. That is, the unit electrodes E2_U may be electrically independent from each other.

In an embodiment, the unit electrode E2_U of the first light-emitting element LEDa may contact the connection pattern CNP. Specifically, the unit electrode E2_U may contact the connection pattern CNP at a position adjacent to or overlapping the separator SPR. The contact area CA where the unit electrode E2_U of the first light-emitting element LEDa contacts the connection pattern CNP may overlap the edge of the separator SPR in the plan view.

For example, in an embodiment, when a deposition angle of a deposition process for forming the second electrode layer is set to be larger than a deposition angle for a deposition process for forming the middle layer ML, the unit electrode E2_U may be formed to cover a side surface of the disconnected middle layer ML and contact the connection pattern CNP. As a result, the unit electrode E2_U may be connected to the output power connection line PV_CL through the connection pattern CNP.

In an embodiment, the second dummy layer DP2 may be disposed on the separator SPR. Specifically, the second dummy layer DP2 may be disposed on the first dummy layer DP1. The second dummy layer DP2 may be formed by having a structure in which the unit electrode E2_U is separated (or disconnected) by the separator SPR. That is, the second dummy layer DP2 may be formed through the same process as the unit electrode E2_U. In another embodiment, the second dummy layer DP2 may be omitted.

In an embodiment, the encapsulation layer ENC may be disposed on the unit electrode E2_U. The encapsulation layer ENC may entirely cover the unit electrode E2_U, the connection pattern CNP, the separator SPR, the first dummy layer DP1, and the second dummy layer DP2. In an embodiment, the encapsulation layer ENC may include a first inorganic encapsulation layer IEL1 including an inorganic insulating material, an organic encapsulation layer OELI disposed on the first inorganic encapsulating layer IEL1 and including an organic insulating material, and a second inorganic encapsulation layer IEL2 disposed on the organic encapsulation layer OEL and including an inorganic insulating material.

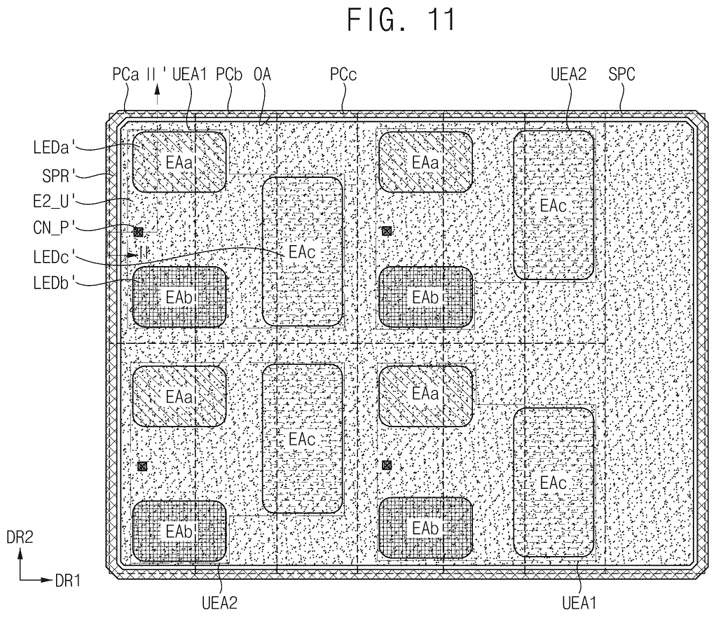

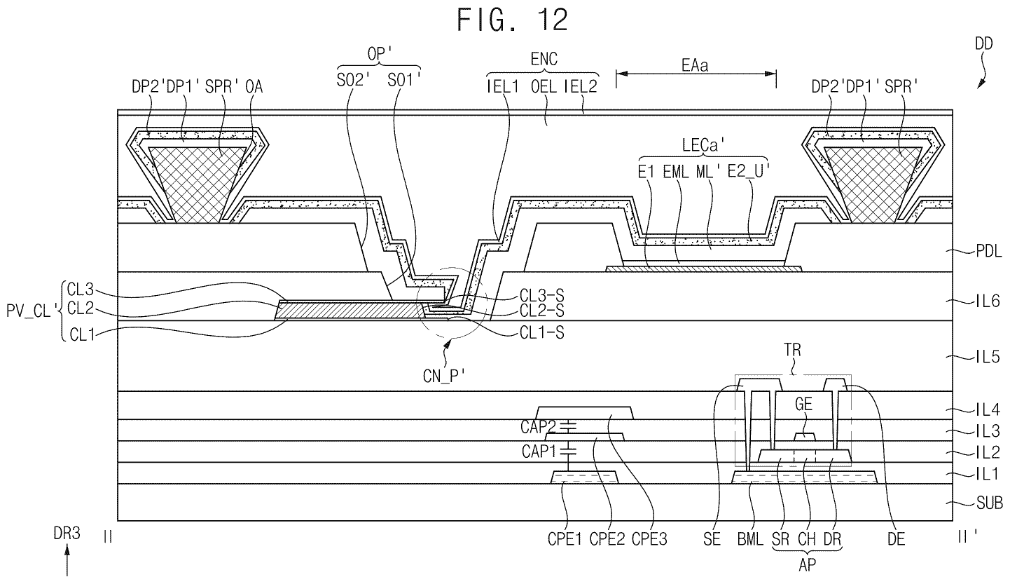

FIG. 11 is an enlarged plan view of one pixel circuit block, light emitting elements connected to the one pixel circuit block, and one switching circuit part of FIG. 7, according to an embodiment. FIG. 12 is a cross-sectional view taken along line II-II′ of FIG. 11, according to an embodiment.

In an embodiment, the display device DD described with reference to FIGS. 7, 11, and 12 may be substantially the same as or similar to the display device DD described with reference to FIGS. 7, 8, 9, and 10 except for an output power connection line PV_CL′ and a light-emitting connection portion CN_P′. Hereinafter, overlapping descriptions will be omitted or simplified.

First, in an embodiment and referring to FIGS. 7 and 11, the display device DD may include the pixel driving circuit parts PCa, PCb, and PCc, the light-emitting elements LEDa′, LEDb′, and LEDc′, the switching circuit part SPC, and a separator SPR′.

In an embodiment, each of the light-emitting elements LEDa′, LEDb′, and LEDc′ may include a first electrode (e.g., the first electrode E1 of FIG. 12), a light-emitting layer disposed on the first electrode (e.g., a light-emitting layer EML of FIG. 12), a middle layer (e.g., the middle layer ML′ of FIG. 12) disposed on the light-emitting layer, and a second electrode layer disposed on the middle layer. In an embodiment, the first electrode may be an anode electrode, and the second electrode layer may be a cathode electrode.

In an embodiment, the separator SPR′ may have a mesh structure surrounding the pixel circuit blocks PCB″ and the switching circuit part SPC in the plan view.

In an embodiment, the second electrode layer of the light-emitting elements LEDa′, LEDb′, and LEDc′ may be separated (or disconnected) by the separator SPR′. Accordingly, the second electrode layer may be separated (or disconnected) into a plurality of unit electrodes E2_U′ spaced apart from each other by the separator SPR′. The unit electrodes E2_U′ may be disposed on each pixel circuit block PCB″. That is, one unit electrode E2_U may be disposed on one pixel circuit block PCB″.

In an embodiment, the separator SPR′ may define open areas OA corresponding to the unit electrodes E2_U′. Each of the unit electrodes E2_U′ may be disposed in the open area OA. For example, the planar shape of each of the unit electrodes E2_U′ may be substantially the same as the planar shape of the open area OA.

For example, in an embodiment, the output power connection line PV_CL′ may be connected to the switching circuit part SPC through a first contact hole CNT1_S, the first power supply voltage line PVL_H may be connected to the switching circuit part SPC through a second contact hole CNT2_S, the second power supply voltage line PVL_L may be connected to the switching circuit part SPC through a third contact hole CNT3_S, and the second data line DL_S may be connected to the switching circuit part SPC through a fourth contact hole CNT4_S.

In an embodiment, in each area where one pixel circuit block PCB″ is disposed, the output power connection line PV_CL′ may be connected to the unit electrode E2_U′ of the light-emitting elements LEDa′, LEDb′, and LEDc′. In an embodiment, the output power connection line PV_CL′ may directly contact the unit electrode E2_U′. Accordingly, the output power connection line PV_CL′ may be electrically connected to the pixel circuit block PCB″.

In an embodiment, the output power connection line PV_CL′ may include a light-emitting connection CN_P′ contacting the unit electrode E2_U′. In an embodiment, there may be at least one light-emitting connection portion CN_P′ each pixel circuit block PCB″ (i.e., one unit electrode E2_U′). For example, as shown in FIG. 11, there may be four light-emitting connection portion CN_P′ each pixel circuit block PCB″ (i.e., one unit electrode E2_U′). However, the invention is not necessarily limited thereto.

For example, the position of the light-emitting connection portion CN_P′ for each pixel circuit block PCB″ (i.e., the unit electrodes E2_U′) may be substantially the same. However, the invention is not necessarily limited thereto.

Hereinafter, the cross-sectional structure of the display device DD will be described in more detail with reference to FIG. 12 centered on the first light-emitting area EAa. The following description regarding the cross-sectional structure of the display device DD may be equally applied to all light emitting areas. In addition, descriptions that overlap with those described with reference to FIGS. 9 and 10 will be omitted or simplified.

In an embodiment and referring further to FIG. 12, the display device DD may include the substrate SUB, the transistor TR, the first capacitor CAP1, the second capacitor CAP2, the first, second, third, fourth, fifth, and sixth insulating layers IL1, IL2, IL3, IL4, IL5, and IL6, respectively, the output power connection line PV_CL′, the pixel defining layer PDL, the first light-emitting element LEDa′, the separator SPR′, a first dummy layer DP1′, a second dummy layer DP2′, and an encapsulation layer ENC sequentially disposed in the third direction DR3.

In an embodiment, the substrate SUB, the transistor TR, the first capacitor CAP1, the second capacitor CAP2 and the insulating layers IL1, IL2, IL3, IL4, IL5, and IL6 may be components of the pixel driving circuit part PCa.

In an embodiment, the output power connection line PV_CL′ may be disposed on the fifth insulating layer IL5. For example, the output power connection line PV_CL′ may include a first conductive layer CL1, a second conductive layer CL2, and a third conductive layer CL3 sequentially stacked.

In an embodiment, the first conductive layer CL1 may include metal and/or transparent conductive oxide. Examples of the metal that can be used as the first conductive layer CL1 may include titanium (Ti), molybdenum (Mo), and the like. Examples of the transparent conductive oxide that can be used as the first conductive layer CL1 may include indium tin oxide (ITO), indium zinc oxide (IZO), zinc oxide (ZnO), indium oxide (InO), indium gallium oxide (IGO), aluminum zinc oxide (AZO), and the like. These can be used alone or in combination with each other. The first conductive layer CL1 may have a relatively thin thickness compared to the second conductive layer CL2.

In an embodiment, the second conductive layer CL2 may include a different material from the first conductive layer CL1. For example, the second conductive layer CL2 may include a different metal from the first conductive layer CL1. Examples of the metal that can be used as the second conductive layer CL2 may include aluminum (Al), copper (Cu), and the like. These can be used alone or in combination with each other. The second conductive layer CL2 may have a relatively thick thickness compared to the first conductive layer CL1.

In an embodiment, the third conductive layer CL3 may include a different material from the second conductive layer CL2. For example, the third conductive layer CL3 may include a different metal and/or transparent conductive oxide than the second conductive layer CL2. Examples of the metal that can be used as the third conductive layer CL3 may include titanium (Ti), molybdenum (Mo), and the like. Examples of the transparent conductive oxide that can be used as the third conductive layer CL3 may include indium tin oxide (ITO), indium zinc oxide (IZO), zinc oxide (ZnO), indium oxide (InO), indium gallium oxide (IGO), aluminum zinc oxide (AZO), and the like. These can be used individually or in combination with each other. The third conductive layer CL3 may have a relatively thin thickness compared to the second conductive layer CL2.

In an embodiment, the first conductive layer CL1 and the third conductive layer CL3 may include the same material. However, the invention is not necessarily limited thereto.

In an embodiment, a side surface CL1-S of the first conductive layer CL1 and a side surface CL3-S of the third conductive layer CL3 may protrude outward from a side surface CL2-S of the second conductive layer CL2. Accordingly, the output power connection line PV_CL′ may have a tip structure due to a portion of the third conductive layer CL3 protruding compared to the second conductive layer CL2. For example, based on the same etching process, when etching the second conductive layer CL2 using an etching material having a higher etch rate for the second conductive layer CL2 compared to the first conductive layer CL1 and the third conductive layer CL3, the output power connection line PV_CL′ may be formed to have the tip structure.

However, the invention is not necessarily limited to this, and in another embodiment, the output power connection line PV_CL′ may have a two-layer structure in which the first conductive layer CL1 is omitted, and the second conductive layer CL2 and the third conductive layer CL3 are stacked.

In an embodiment, unlike shown in FIG. 12, the output power connection line PV_CL′ may contact the unit electrode E2_U′ through a pixel connection pattern and an auxiliary line, as shown in FIG. 10. In this case, the auxiliary line may have a three-layer structure including three sequentially stacked conductive layers and may have a tip structure.

In an embodiment, the sixth insulating layer IL6 may define a first sub-opening SO1′ exposing at least a portion of the output power connection line PV_CL′. Specifically, the first sub-opening SO1′ may expose the tip structure (i.e., the first, second, and third side surfaces CL1-S, CL2-S, and CL3-S) of the output power connection line PV_CL′.

In an embodiment, the pixel defining layer PDL may further define a second sub-opening SO2′ corresponding to the first sub-opening SO1′ of the sixth insulating layer IL6. The second sub-opening SO2′ may overlap the first sub-opening SO1′ in the plan view, and the first sub-opening SO1′ and the second sub-opening SO2′ may be spatially connected to each other. That is, an opening OP′ connected to the first sub-opening SO1′ and the second sub-opening SO2′ may be defined, and the opening OP′ may expose at least a portion of the output power connection line PV_CL′. Specifically, the opening OP′ may expose the tip structure (i.e., the first, second, and third side surfaces CL1-S, CL2-S, and CL3-S) of the output power connection line PV_CL′.

In an embodiment, the separator SPR′ may be disposed on the pixel defining layer PDL. The separator SPR′ may have a shape where an upper width is larger than a lower width. That is, a side surface of the separator SPR′ connecting an upper surface of the separator SPR′ and a lower surface of the separator SPR′ may have a reverse tapered slope. In other words, the cross section of the separator SPR′ may be a truncated trapezoidal.

In an embodiment, as shown in FIG. 12, the side surface of the separator SPR′ may have one reverse tapered slope. However, the invention is not necessarily limited thereto, the side surface of the separator SPR′ may have a plurality of reverse tapered slopes. That is, the separator SPR′ may have a double reverse tapered structure.

In an embodiment, the first dummy layer DP1′ may be disposed on the separator SPR′. The first dummy layer DP1′ may be formed by having a structure in which the middle layer ML′ is separated (or disconnected) by the separator SPR′.

In an embodiment, the middle layer ML′ may also be separated (or disconnected) by the tip structure of the output power connection line PV_CL′. As the middle layer ML′ is separated (or disconnected) by the tip structure of the output power connection line PV_CL′, the middle layer ML′ may expose at least a portion of the side surface CL2-S of the second conductive layer CL2. Accordingly, the unit electrode E2_U′ of the first light-emitting element LEDa′ may contact the side surface CL2-S of the second conductive layer CL2 and the side surface CL3-S of the third conductive layer CL3.

In an embodiment, the unit electrode E2_U′ of the first light-emitting element LEDa′ may be connected to the output power connection line PV_CL′. Specifically, the unit electrode E2_U′ may contact the side surface CL2-S of the second conductive layer CL2. For example, when the deposition angle of the deposition process for forming the second electrode layer is set to be larger than the deposition angle for the deposition process for forming the middle layer ML′, the unit electrode E2_U′ may be formed to contact the side surface CL2-S of the second conductive layer CL2 while covering the middle layer ML′ disconnected by the tip structure. As a result, the unit electrode E2_U′ may contact the output power connection line PV_CL′ by the tip structure of the output power connection line PV_CL′.

In an embodiment, the second electrode layer may be separated (or disconnected) by the tip structure of the output power connection line PV_CL′. However, the invention is not necessarily limited to this, and the second electrode layer may be formed to extend rather than be disconnected by the tip structure.

In an embodiment, the second dummy layer DP2′ may be disposed on the separator SPR′. Specifically, the second dummy layer DP2′ may be disposed on the first dummy layer DP1′. The second dummy layer DP2′ may be formed by having a structure in which the second electrode layer is separated (or disconnected) by the separator SPR′.

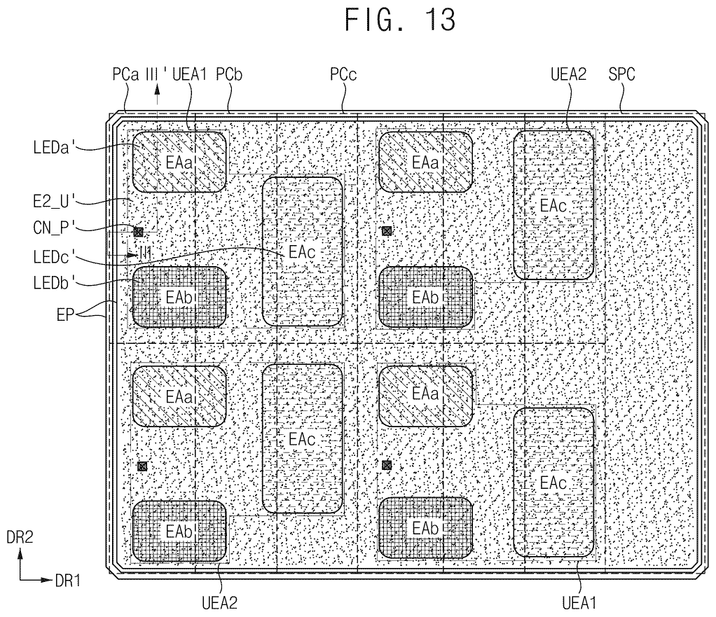

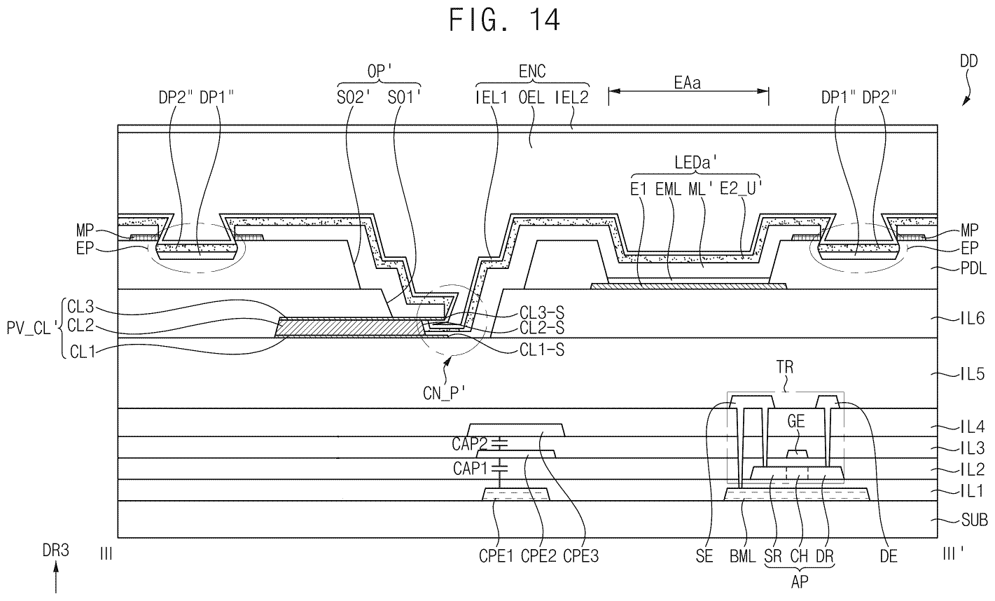

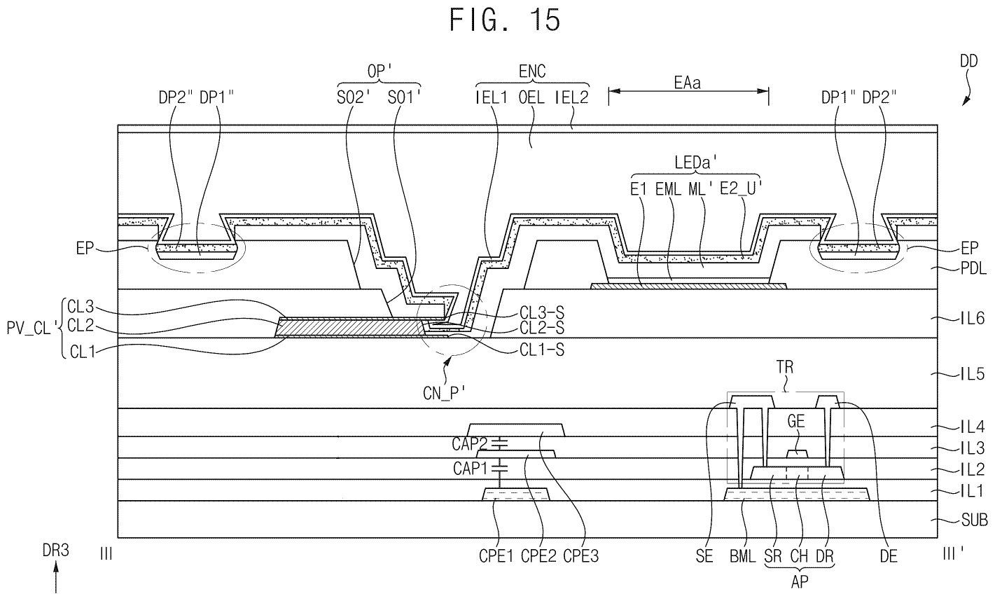

FIG. 13 is an enlarged plan view of one pixel circuit block, light emitting elements connected to the one pixel circuit block, and one switching circuit part of FIG. 7, according to an embodiment. FIG. 14 is a cross-sectional view showing an example of a cross-section taken along line III-III′ of FIG. 13, according to an embodiment. FIG. 15 is a cross-sectional view showing an example of a cross-section taken along line III-III′ of FIG. 13, according to an embodiment.

In an embodiment, the display device DD described with reference to FIGS. 7, 13, 14, and 15 may be substantially the same as or similar to the display device DD described with reference to FIGS. 11 and 12 except for an engraved pattern EP. Hereinafter, overlapping descriptions will be omitted or simplified.

First, in an embodiment and referring to FIGS. 7 and 13, the display device DD may include the pixel driving circuit parts PCa, PCb, and PCc, the light-emitting elements LEDa′, LEDb′, and LEDc′, the switching circuit part SPC, and an engraved pattern EP disposed in the display area DA.

In an embodiment, the engraved pattern EP may have a mesh structure surrounding the pixel circuit blocks PCB″ and the switching circuit part SPC in the plan view. Specifically, the engraved pattern EP may be disposed between adjacent pixel circuit blocks PCB″, and may be disposed between the switching circuit part SPC and the pixel circuit block PCB″ disposed adjacent to the switching circuit part SPC in the first direction DR1. However, the invention is not limited to this, and the engraved pattern EP may have a mesh structure surrounding the light emitting areas EAa, EAb, and EAc in the plan view.

In an embodiment, the engraved pattern EP may be formed by removing a portion of the pixel defining layer (e.g., the pixel defining layer PDL of FIG. 15).

In an embodiment, the second electrode layer of the light-emitting elements LEDa′, LEDb′, and LEDc′ may be separated (or disconnected) by the engraved pattern EP. Accordingly, the second electrode layer may be separated (or disconnected) into a plurality of unit electrodes E2_U′ spaced apart from each other by the engraved pattern EP. The unit electrodes E2_U may be disposed on each pixel circuit block PCB″. That is, one unit electrode E2_U may be disposed on one pixel circuit block PCB″. The unit electrodes E2_U may be electrically independent from each other.

For example, in an embodiment, the output power connection line PV_CL′ may be connected to the switching circuit part SPC through the first contact hole CNT1_S, the first power supply voltage line PVL_H may be connected to the switching circuit part SPC through the second contact hole the second contact hole CNT2_S, the second power supply voltage line PVL_L may be connected to the switching circuit part SPC through the third contact hole CNT3_S, and the second data line DL_S may be connected to the switching circuit part SPC through the fourth contact hole CNT4_S.

In an embodiment, in each area where one pixel circuit block PCB″ is disposed, the output power connection line PV_CL′ may be connected to the unit electrode E2_U′ of the first, second, and third light-emitting elements LEDa′, LEDb′, and LEDc′. In an embodiment, the output power connection line PV_CL′ may directly contact the unit electrode E2_U′. Accordingly, the output power connection line PV_CL′ may be electrically connected to the pixel circuit block PCB″.

In an embodiment, the output power connection line PV_CL′ may include the light-emitting connection portion CN_P′ contacting the unit electrode E2_U′. In an embodiment, there may be at least one light-emitting connection portion CN_P′ each pixel circuit block PCB″ (i.e., one unit electrode E2_U′). For example, as shown in FIG. 13, there may be four light-emitting connection portion CN_P′ each pixel circuit block PCB″ (i.e., one unit electrode E2_U′). However, the invention is not necessarily limited thereto.

For example, in an embodiment, the position of the light-emitting connection portion CN_P′ for each pixel circuit block PCB″ (i.e., unit electrodes E2_U′) may be substantially the same. However, the invention is not necessarily limited thereto.

Hereinafter, the cross-sectional structure of the display device DD will be described in more detail with reference to FIGS. 14 and 15 centered on the first light-emitting area EAa. In an embodiment, the following description regarding the cross-sectional structure of the display device DD may be equally applied to all light-emitting areas. In addition, descriptions that overlap with those described with reference to FIGS. 9, 10, and 12 will be omitted or simplified.

In an embodiment and referring further to FIGS. 14 and 15, the display device DD may include the substrate SUB, the transistor TR, the first capacitor CAP1, the second capacitor CAP2, the insulating layers IL1, IL2, IL3, IL4, IL5, and IL6, the output power connection line PV_CL′, the pixel defining layer PDL, the first light-emitting element LEDa′, the engraved pattern EP, a first dummy layer DP1″, a second dummy layer DP2″, and an encapsulation layer ENC sequentially disposed in the third direction DR3.

In an embodiment, the substrate SUB, the transistor TR, the first capacitor CAP1, the second capacitor CAP2 and the insulating layers IL1, IL2, IL3, IL4, IL5, and IL6 may be components of the pixel driving circuit part PCa.

In an embodiment, the output power connection line PV_CL′ may be disposed on the fifth insulating layer IL5. For example, the output power connection line PV_CL′ may include the first conductive layer CL1, the second conductive layer CL2, and the third conductive layer CL3 sequentially stacked. That is, the output power connection line PV_CL′ may be substantially the same as the output power connection line PV_CL′ of FIG. 12.

In an embodiment, the side surface CL1-S of the first conductive layer CL1 and the side surface CL3-S of the third conductive layer CL3 may protrude outward from the side surface CL2-S of the second conductive layer CL2. Accordingly, the output power connection line PV_CL′ may have a tip structure due to the portion of the third conductive layer CL3 that protruding compared to the second conductive layer CL2.

In an embodiment, unlike shown in FIGS. 14 and 15, the output power connection line PV_CL′ may contact the unit electrode E2_U′ through a pixel connection pattern and an auxiliary line, as shown in FIG. 10. In this case, the auxiliary line may have a three-layer structure including three sequentially stacked conductive layers and may have the tip structure.

In an embodiment, the pixel defining layer PDL may include the engraved pattern EP. The engraved pattern EP may be formed by removing a portion of the pixel defining layer PDL. That is, the sixth insulating layer IL6 may not be exposed by the engraved pattern EP. The engraved pattern EP may replace the role of the separators SPR and SPR′ of FIGS. 7, 8, 9, 10, 11, and 12.

In an embodiment, the middle layer ML′ may have a structure separated (or disconnected) by the engraved pattern EP. The first dummy layer DP1″ may be disposed in the engraved pattern EP. The first dummy layer DP1″ may be formed by having a structure in which the middle layer ML′ is separated (or disconnected) by the engraved pattern EP.

In an embodiment, the middle layer ML′ may also be separated (or disconnected) by the tip structure of the output power connection line PV_CL′. As the middle layer ML′ is separated (or disconnected) by the tip structure of the output power connection line PV_CL′, the middle layer ML′ may expose at least a portion of the side surface CL2-S of the second conductive layer CL2. Accordingly, the unit electrode E2_U′ of the first light-emitting element LEDa′ may contact the side surface CL2-S of the second conductive layer CL2.

In an embodiment, the unit electrode E2_U′ of the first light-emitting element LEDa′ may be connected to the output power connection line PV_CL′. Specifically, the unit electrode E2_U′ may contact the side surface CL2-S of the second conductive layer CL2.

In an embodiment, the second electrode layer may have a structure separated (or disconnected) by the engraved pattern EP. The second dummy layer DP2″ may be disposed in the engraved pattern EP. Specifically, the second dummy layer DP2″ may be disposed on the first dummy layer DP1″. The second dummy layer DP2′ may be formed by having a structure in which the second electrode layer is separated (or disconnected) by the engraved pattern EP.

In an embodiment, the second electrode layer may be separated (or disconnected) by the tip structure of the output power connection line PV_CL′. However, the invention is not necessarily limited to this, and the second electrode layer may be formed to extend rather than be disconnected by the tip structure.

In an embodiment, as shown in FIG. 14, the display device DD may further include a metal pattern MP disposed on the pixel defining layer PDL, overlapping the edge of the engraved pattern EP in the plan view, and covered by the middle layer ML′. The metal pattern MP may have a tip structure protruding toward the engraved pattern EP. For example, the metal pattern MP may include transparent conductive oxide. In another embodiment, the metal pattern MP may include a conductive material such as a metal, alloy, conductive metal nitride, and the like. However, the invention is not necessarily limited to this, and as shown in FIG. 15, the metal pattern MP may be omitted.

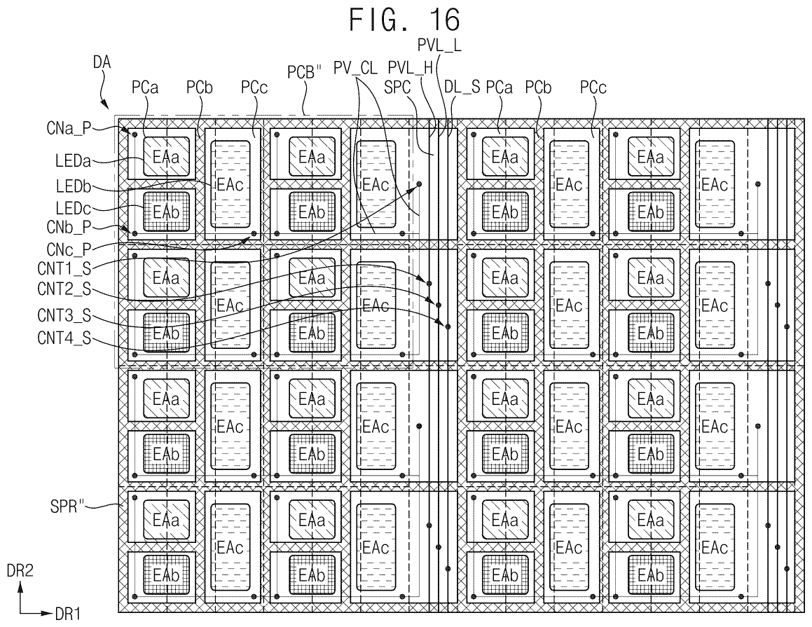

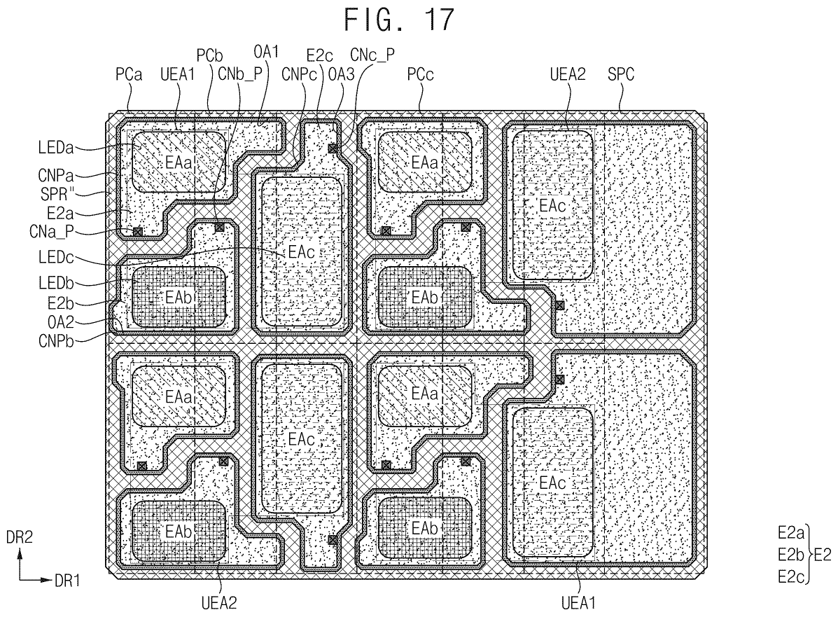

FIG. 16 is a plan view schematically showing a portion of a display area of FIGS. 1A and 1B, according to an embodiment. FIG. 17 is an enlarged plan view of one pixel circuit block, light emitting elements connected to the one pixel circuit block, and one switching circuit part of FIG. 16, according to an embodiment.

In an embodiment, the display device DD described with reference to FIGS. 16 and 17 may be substantially the same as or similar to the display device DD described with reference to FIGS. 7 and 8 except for a separator SPR″. Hereinafter, overlapping descriptions will be omitted or simplified.

In an embodiment and referring to FIGS. 16 and 17, the display device DD may include the pixel driving circuit parts PCa, PCb, and PCc, the light-emitting elements LEDa, LEDb, and LEDc, the connection patterns CNPa, CNPb, and CNPc, the switching circuit part SPC, and the separator SPR″.

In an embodiment, each of the light-emitting elements LEDa, LEDb, and LEDc may include a first electrode (e.g., the first electrode E1 of FIGS. 9 and 10), a light-emitting layer disposed on the first electrode (e.g., a light-emitting layer EML of FIGS. 9 and 10), a middle layer (e.g., the middle layer ML′ of FIGS. 9 and 10) disposed on the light-emitting layer, and a second electrode layer disposed on the middle layer. In an embodiment, the first electrode may be an anode electrode, and the second electrode layer may be a cathode electrode.

In an embodiment, the second electrode layer E2 may be separated (or disconnected) by the separator SPR″. Accordingly, the second electrode layer E2 may be separated (or disconnected) into the second electrodes E2a, E2b, and E2c spaced apart from each other by the separator SPR″. That is, the second electrode E2a of the first light-emitting element LEDa, the second electrode E2b of the second light-emitting element LEDb, and the second electrode E2c of the third light-emitting element LEDc may be electrically independent from each other by the separator SPR″.

In an embodiment, the separator SPR″ may have a mesh structure surrounding the light-emitting areas EAa, EAb, and EAc and the second electrodes E2a, E2b, and E2c in the plan view. Accordingly, leakage current of the display device DD may be reduced.

In an embodiment, the separator SPR″ may define open areas OA1, OA2, and OA3 respectively corresponding to the second electrodes E2a, E2b, and E2c. The second electrode E2a of the first light-emitting element LEDa may be disposed in the first open area OA1, the second electrode E2b of the second light-emitting element LEDb may be disposed in the second open area OA2, and the second electrode E2c of the third light-emitting element LEDc may be disposed in the third open area OA3.

In an embodiment, the planar shape of the first open area OA1 may be substantially the same as the planar shape of the second electrode E2a of the first light-emitting element LEDa, the planar shape of the second open area OA2 may be substantially the same as the planar shape of the second electrode E2b of the second light-emitting element LEDb, and the planar shape of the third open area OA3 may be substantially the same as the planar shape of the second electrode E2c of the third light-emitting element LEDc.

In an embodiment, each of the connection patterns CNPa, CNPb, and CNPc may not overlap the light-emitting areas EAa, EAb, and EAc in the plan view. In an embodiment, each of the connection patterns CNPa, CNPb, and CNPc may surround at least a portion of the light-emitting areas EAa, EAb, and EAc in the plan view. For example, each of the connection patterns CNPa, CNPb, and CNPc may have a closed ring shape entirely surrounding the light-emitting areas EAa, EAb, and EAc in the plan view. However, the invention is not necessarily limited thereto.

In an embodiment, the output power connection line PV_CL may be connected to the light-emitting elements LEDa, LEDb, and LEDc through the connection patterns CNPa, CNPb, and CNPc. Specifically, the output power connection line PV_CL may be connected to the second electrode E2a of the first light-emitting element LEDa through the first connection pattern CNPa, may be connected to the second electrode E2b of the second light-emitting element LEDb through the second connection pattern CNPb, and may be connected to the second electrode E2c of the third light-emitting element LEDc through the third connection pattern CNPc. Accordingly, the output power connection line PV_CL may be electrically connected to the pixel circuit block PCB″. As a result, the switching circuit part SPC may be electrically connected to the pixel circuit block PCB″ through the output power connection line PV_CL.

In an embodiment, the materials and cross-sectional structures of the connection patterns CNPa, CNPb, and CNPc may be substantially the same as the materials and cross-sectional structures of the connection patterns CNP of FIGS. 7, 8, 9, and 10.

In an embodiment, the output power connection line PV_CL may include a first light-emitting connection portion CNa_P contacting the first connection pattern CNPa, a second light-emitting connection portion CNb_P contacting the second connection pattern CNPb, and a third light-emitting connection part CNc_P contacting the third connection pattern CNPc.

For example, in an embodiment, the positions of the light-emitting connection portions CNa_P, CNb_P, and CNc_P in each first unit light-emitting area UEA1 may be substantially the same. In addition, the positions of the light-emitting connection portions CNa_P, CNb_P, and CNc_P in each second unit light-emitting area UEA2 may be substantially the same. However, the invention is not necessarily limited thereto.

In an embodiment, the planar profile of an area where the first connection pattern CNPa and the second electrode E2a of the first light-emitting element LEDa contact may be substantially the same or similar to the planar profile of the edge of the first connection pattern CNPa. For example, when the first connection pattern CNPa has a closed ring shape entirely surrounding the first light-emitting area EAa in the plan view, the area where the first connection pattern CNPa and the second electrode E2a of the first light-emitting element LEDa contact may have a closed ring shape in the plan view.

Likewise, in an embodiment, the planar profile of an area where the second connection pattern CNPb and the second electrode E2b of the second light-emitting element LEDb contact may be substantially the same as or similar to the planar profile of the edge of the second connection pattern CNPb, and the planar profile of an area where the third connection pattern CNPc and the second electrode E2c of the third light-emitting element LEDc contact may be substantially the same as or similar to the planar profile of the edge of the third connection pattern CNPc.

In an embodiment, the separator SPR″ may overlap the connection patterns CNPa, CNPb, and CNPc in the plan view. Specifically, the separator SPR″ may cover a portion of the connection patterns CNPa, CNPb, and CNPc and the adjacent connection patterns CNPa, CNPb, and CNPc. That is, at least a portion of the separator SPR″ may extend along the edges of each of the connection patterns CNPa, CNPb, and CNPc in the plan view. Accordingly, the connection patterns CNPa, CNPb, and CNPc may partially overlap the area where the separator SPR″ is disposed in the plan view.

In an embodiment, the cross-sectional structure of each light-emitting area of FIGS. 16 and 17 may be substantially the same as or similar to the cross-sectional structure of any one of FIGS. 9, 10, and 12. If the cross-sectional structure of each light-emitting area of FIGS. 16 and 17 is substantially the same or similar to the cross-sectional structure of FIG. 12, the connection patterns CNPa, CNPb, and CNPc may be omitted.

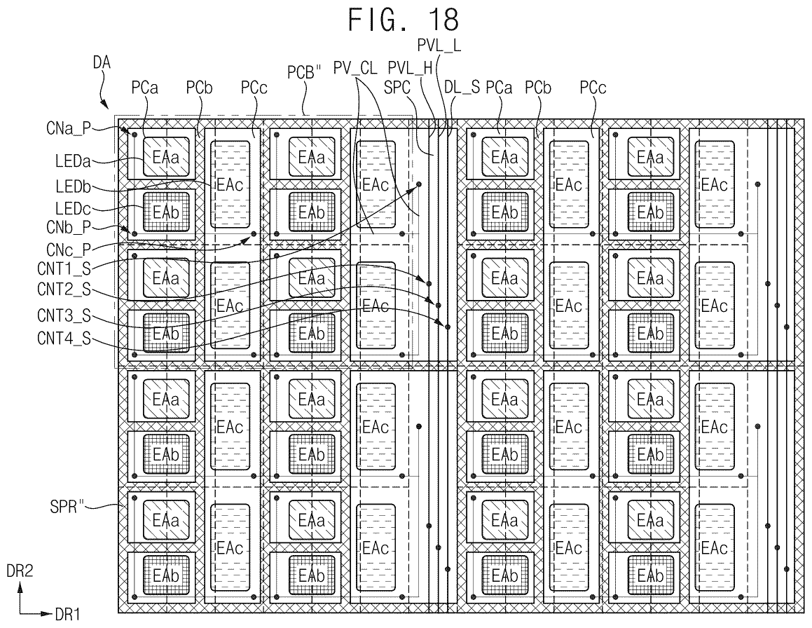

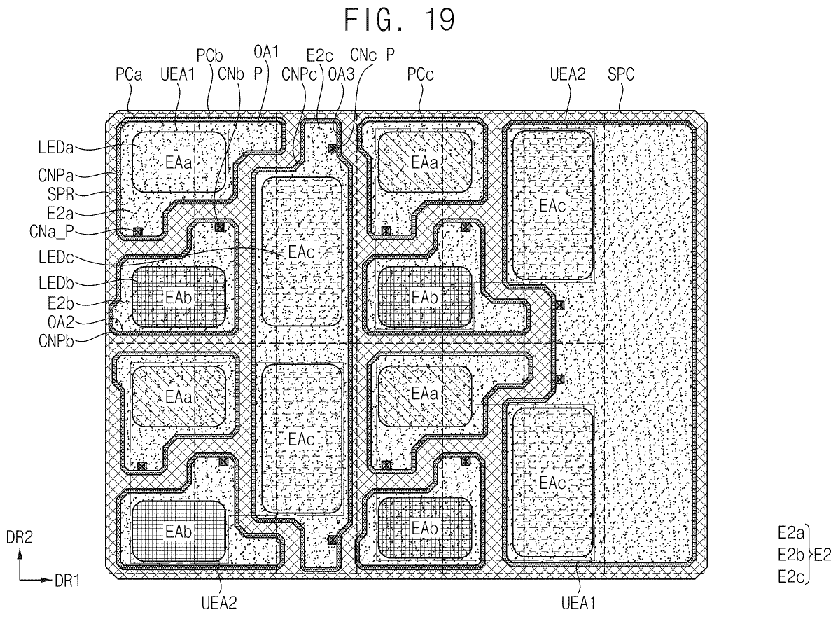

FIG. 18 is a plan view schematically showing a portion of a display area of FIGS. 1A and 1B, according to an embodiment. FIG. 19 is an enlarged plan view of one pixel circuit block, light emitting elements connected to the one pixel circuit block, and one switching circuit part of FIG. 18, according to an embodiment.

In an embodiment, the display device DD described with reference to FIGS. 18 and 19 may be substantially the same as or similar to the display device DD described with reference to FIGS. 16 and 17 except for the separator SPR″. Hereinafter, overlapping descriptions will be omitted or simplified.

In an embodiment and referring to FIGS. 18 and 19, the display device DD may include the pixel driving circuit parts PCa, PCb, and PCc, the light-emitting elements LEDa, LEDb, and LEDc, the connection patterns CNPa, CNPb, and CNPc, the switching circuit part SPC, and the separator SPR″ disposed in the display area DA.

In an embodiment, the second electrode layer E2 may be separated (or disconnected) by a separator SPR″. Accordingly, the second electrode layer E2 may be separated (or disconnected) into the second electrodes E2a, E2b, and E2c spaced apart from each other by the separator SPR″. That is, the second electrode E2a of the first light-emitting element LEDa, the second electrode E2b of the second light-emitting element LEDb, and the second electrode E2c of the third light-emitting element LEDc may be electrically independent from each other by the separator SPR″.

In an embodiment, the separator SPR″ may have a mesh structure surrounding the light-emitting areas EAa, EAb, and EAc and the second electrodes E2a, E2b, and E2c in the plan view. In this case, in one pixel circuit block PCB″, the separator SPR″ may not be disposed between adjacent third light-emitting areas EAc. The separator SPR″ may be disposed between the third light-emitting areas EAc corresponding to adjacent pixel circuit blocks PCB″.

In an embodiment, the cross-sectional structure of each light-emitting area of FIGS. 18 and 19 may be substantially the same as or similar to the cross-sectional structure of any one of FIGS. 9, 10, and 12. When the cross-sectional structure of each light-emitting area of FIGS. 16 and 17 may be substantially the same or similar to the cross-sectional structure of FIG. 12, the connection patterns CNPa, CNPb, and CNPc may be omitted.

In an embodiment and referring again to FIGS. 6, 7, 8, 9, 10, 11, 12, 13, 14, 15, 16, 17, 18, and 19, the display device DD may include a plurality of pixel circuit blocks each including at least one pixel driving circuit part, and a switching circuit part SPC electrically connected one-to-one with the pixel circuit blocks and which selectively provides the first power supply voltage ELVSS_H of the high level or the first power supply voltage ELVSS_L of the low level. The plurality of transistors may include a driving transistor which generates the driving current ID and be a PMOS transistor. For example, the first power supply voltage ELVSS_L of the low level may be applied to the pixel circuit blocks disposed in a high-brightness area of the display area DA, and the first power supply voltage ELVSS_H of the high level may be applied to the pixel circuit blocks disposed in a low-brightness area of the display area. Accordingly, a power consumption of the display device DD may be reduced.

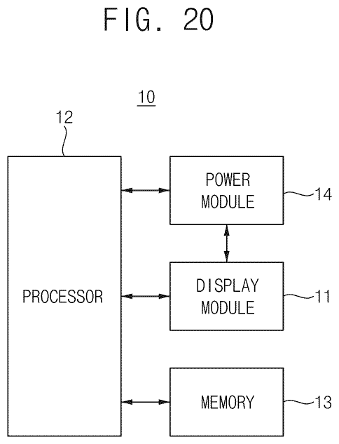

FIG. 20 is a block diagram showing an electronic device, according to an embodiment.

In an embodiment and referring to FIG. 20, an electronic device 10 may include a display module 11, a processor 12, a memory 13, and a power module 14.

A display device according to an embodiment (e.g., the display device DD or the display device DDa of FIGS. 1 to 19) may be applied to various electronic devices 10. The electronic device 10 may include the display device described above, and may further include modules or devices with additional functions other than the display device.

In an embodiment, the processor 12 may include at least one of a central processing unit (CPU), an application processor (AP), a graphic processing unit (GPU), a communication processor (CP), an image signal processor (ISP), and a controller. The processor 12 may control the display device.

In an embodiment, the memory 13 may store data information necessary for the operation of the processor 12 or the display module 11. When the processor 12 executes the application stored in the memory 13, an image data signal and/or an input control signal may be transmitted to the display module 11, and the display module 11 may process the received signal and output image information through a display screen.

In an embodiment, the power module 14 may include a power supply module, such as a power adapter or a battery device, and a power conversion module which converts the power supplied by the power supply module to generate power required for the operation of the electronic device 10.

In an embodiment, at least one of each component of the electronic device 10 described above may be included in the display device. In addition, some of the individual modules functionally included in one module may be included in the display device, and other portions may be provided separately from the display device. For example, in another embodiment, the display device may include the display module 11, and the processor 12, the memory 13, and the power module 14 may be provided in the form of other devices within the electronic device 10 other than the display device.

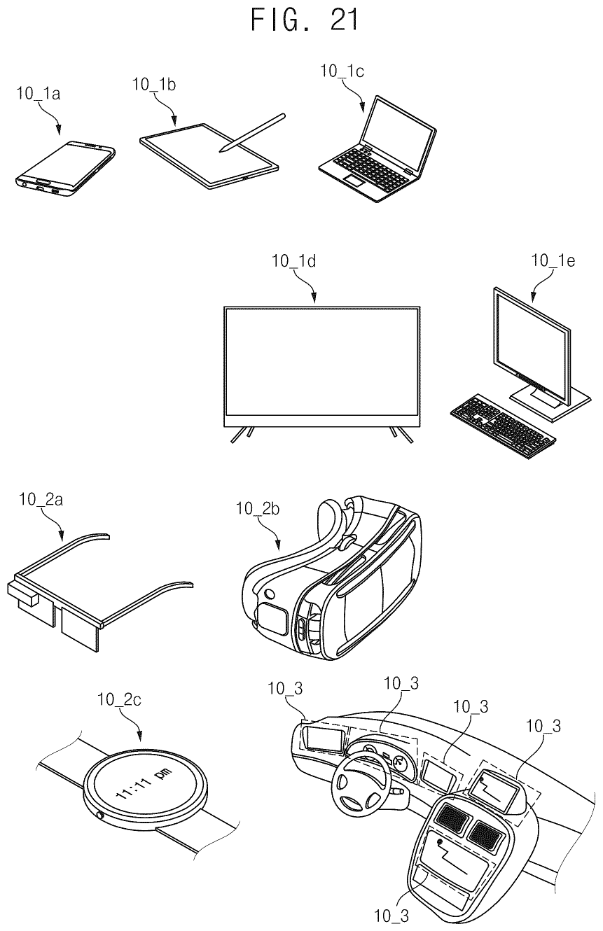

FIG. 21 are schematic diagrams showing an electronic device, according to various embodiments.

In an embodiment and referring to FIG. 21, various electronic devices 10 to which display devices according to the embodiments (e.g., the display device DD or the display device DDa of FIGS. 1 to 19) are applied may include not only image display electronic devices such as a smartphone 10_1a, a tablet PC 10_1b, a laptop 10_1c, a TV 10_1d, and a desktop monitor 10_1e, but also wearable electronic devices including display modules, such as smart glasses 10_2a, a head-mounted display 10_2b, and a smart watch 10_2c, automotive electronic devices 10_3 including display modules, such as a dashboard of a car, a center fascia, a Center Information Display (CID) disposed on a dashboard, and a room mirror display, or the like.

The invention can be applied to various display devices. For example, the invention is applicable to various display devices such as display devices for vehicles, ships and aircraft, portable communication devices, display devices for exhibition or information transmission, medical display devices, and the like.

The foregoing is illustrative of embodiments and is not to be construed as limiting thereof. Although a few embodiments have been described, those skilled in the art will readily appreciate that many modifications are possible in the invention without materially departing from the novel teachings and advantages of the invention. Accordingly, all such modifications are intended to be included within the scope of the invention. Therefore, it is to be understood that the foregoing is illustrative of various embodiments and is not to be construed as limited to the specific embodiments disclosed, and that modifications to the disclosed embodiments, as well as other embodiments, are intended to be included within the scope of the invention.

What is claimed is:

1. A display device comprising:
a plurality of pixel circuit blocks each including at least one pixel driving circuit part including a plurality of transistors;
a light-emitting element electrically connected to the pixel driving circuit part and including an anode electrode and a cathode electrode;
a first power supply voltage line which receives a power supply voltage of a high level;
a second power supply voltage line which receives a power supply voltage of a low level;
a switching circuit part electrically connected to the plurality of pixel circuit blocks on a one-to-one basis and including:
a first switching element connected to the first power supply voltage line, wherein the first switching element is turned on by a data voltage of a first voltage level; and
a second switching element connected to the second power supply voltage line wherein the second switching element is turned on by a data voltage of a second voltage level different from the first voltage level; and
a data line electrically connected to the switching circuit part, wherein the data line provides the data voltage of the first voltage level or the data voltage of the second voltage level to the switching circuit part.

2. The display device of claim 1, wherein the switching circuit part selectively provides the power supply voltage of the high level or the power supply voltage of the low level to any one of the plurality of pixel circuit blocks electrically connected to the switching circuit part.

3. The display device of claim 1, wherein the first switching element is turned off by the data voltage of the second voltage level and the second switching element is turned off by the data voltage of the first voltage level.

4. The display device of claim 3, wherein when the first switching element is turned on, the second switching element is turned off, and
when the first switching element is turned off, the second switching element is turned on.

5. The display device of claim 1, wherein when the first switching element is a PMOS transistor, the second switching element is a NMOS transistor, and
when the first switching element is a NMOS transistor, the second switching element is a PMOS transistor.

6. The display device of claim 1, wherein a power line to which a common voltage is applied is connected to the cathode electrode, and
the power supply voltage is a driving voltage having a voltage level higher than a voltage level of the common voltage.

7. The display device of claim 6, wherein the plurality of transistors include a switching transistor including a gate electrode controlled by a light-emitting control signal, a source electrode, and a drain electrode,
further comprising:
an output power connection line connecting the source electrode of the switching transistor and the switching circuit part, wherein the output power connection line selectively receives the power supply voltage of the high level or the power supply voltage of the low level through the switching circuit part.

8. The display device of claim 1, further comprising:
an output power connection line connecting the anode electrode and the switching circuit part, wherein the output power connection line selectively receives the power supply voltage of the high level or the power supply voltage of the low level through the switching circuit part.

9. The display device of claim 1, further comprising:
an output power connection line connecting the cathode electrode and the switching circuit part, wherein the output power connection line selectively receives the power supply voltage of the high level or the power supply voltage of the low level through the switching circuit part.

10. The display device of claim 9, further comprising:
a separator disposed on the pixel driving circuit part and surrounding the pixel circuit blocks in a plan view,
wherein the cathode electrode is disconnected by the separator.

11. The display device of claim 10, wherein a side surface of the separator has a reverse tapered slope.

12. The display device of claim 10, wherein the pixel driving circuit part includes:
an inorganic insulating layer disposed on a substrate;
a first organic insulating layer disposed on the inorganic insulating layer;
a second organic insulating layer disposed on the first organic insulating layer and defining a first sub-opening exposing at least a portion of the output power connection line; and
a pixel defining layer disposed on the second organic insulating layer and defining a second sub-opening spatially connected to the first sub-opening.

13. The display device of claim 12, further comprising:
a connection pattern disposed on the pixel defining layer, contacting the cathode electrode in an area overlapping an edge of the separator, and contacting the output power connection line through the first sub-opening and the second sub-opening.

14. The display device of claim 13, wherein the light-emitting element further includes a light-emitting layer disposed between the anode electrode and the cathode electrode, and overlapping a light-emitting area, wherein
the connection pattern has a shape surrounding the light-emitting area in a plan view.

15. The display device of claim 14, wherein the connection pattern is spaced apart from the light-emitting area in the plan view.

16. The display device of claim 12, wherein the output power connection line includes a first conductive layer, a second conductive layer, and a third conductive layer sequentially stacked, wherein
a side surface of each of the first conductive layer and the third conductive layer protrudes outward beyond a side surface of the second conductive layer.

17. The display device of claim 16, wherein the cathode electrode is disconnected by the output power connection line, and
wherein the cathode electrode contacts the side surface of the second conductive layer and the side surface of the third conductive layer.

18. The display device of claim 9, wherein the pixel driving circuit part includes:
an inorganic insulating layer disposed on a substrate;
a first organic insulating layer disposed on the inorganic insulating layer;
a second organic insulating layer disposed on the first organic insulating layer and defining a first sub-opening exposing at least a portion of the output power connection line;
a pixel defining layer disposed on the second organic insulating layer and defining a second sub-opening spatially connected to the first sub-opening, wherein
the pixel defining layer includes an engraved pattern surrounding the pixel circuit blocks in a plan view.

19. The display device of claim 18, wherein the cathode electrode is disconnected by the engraved pattern.

20. An electronic device comprising:
a display device; and
a processor which controls the display device,
wherein the display device includes:
a plurality of pixel circuit blocks each including at least one pixel driving circuit part including a plurality of transistors;
a light-emitting element electrically connected to the pixel driving circuit part and including an anode electrode and a cathode electrode;
a first power supply voltage line which receives a power supply voltage of a high level;
a second power supply voltage line which receives a power supply voltage of a low level;
a switching circuit part electrically connected to the plurality of pixel circuit blocks on a one-to-one basis and including:
a first switching element connected to the first power supply voltage line, wherein the first switching element is turned on by a data voltage of a first voltage level; and
a second switching element connected to the second power supply voltage line, wherein the second switching element is turned on by a data voltage of a second voltage level different from the first voltage level; and
a data line electrically connected to the switching circuit part, wherein the data line provides the data voltage of the first voltage level or the data voltage of the second voltage level to the switching circuit part.
